(19) United States
(12) Patent Application Publication
(10) Pub. No.: US 2015/0249587 A1
(43) Pub. Date: Sep. 3, 2015

(54) METHOD AND APPARATUS FOR TOPOLOGY AND PATH VERIFICATION IN NETWORKS

(71) Applicant: NTT DOCOMO, INC., Palo Alto, CA (US)

(72) Inventors: Ulas C. Kozat, Palo Alto, CA (US); Guanfeng Liang, Sunnyvale, CA (US); Koray Kokten, Istanbul (TR)

(21) Appl. No.: 14/429,707

(22) PCT Filed: Sep. 4, 2013
(86) PCT No.: PCT/US2013/058096

§ 371 Date: Mar. 19, 2015

Related U.S. Application Data
(60) Provisional application No. 61/703,704, filed on Sep. 20, 2012.
(60) Provisional application No. 61/805,896, filed on Mar. 27, 2013.

(51) Int. Cl. H04L 12/26; H04L 12/437; H04L 12/813; H04L 12/733; H04L 12/721; H04L 12/24

(52) U.S. Cl. CPC H04L 43/0811; H04L 45/38; H04L 41/12; H04L 47/20; H04L 45/122; H04L 12/437; H04L 41/0677

(57) ABSTRACT

A method and apparatus are disclosed herein for topology and/or path verification in networks. In one embodiment, a method is disclosed for use with a pre-determined subset of network flows for a communication network, where the network comprises a control plane, a forwarding plane, and one or more controllers. The method comprises installing forwarding rules on the forwarding elements for identification of network information, wherein the forwarding rules are grouped into one or more separate control flows, where each of the one or more control flows makes a closed loop walk through at least a portion of the network according to the forwarding rules of said each control flow, injecting traffic for one or more control flows onto the forwarding plane, and identifying the network information based on results of injecting the traffic.

### PRIORITY

The present patent application claims priority to and incorporates by reference the corresponding provisional patent application Ser. No. 61/703,704, titled, “A Method and Apparatus for Topology and Path Verification in Partitioned Openflow Networks”, filed on Sep. 20, 2012, and provisional patent application Ser. No. 61/805,896, titled “A Method and Apparatus for Verifying Forwarding Plane Connectivity in Split Architectures”, filed on Mar. 27, 2013.

### FIELD OF THE INVENTION

Embodiments of the present invention relate to the field of network topology; more particularly, embodiments of the present invention relate to verifying the topology and paths in networks (e.g., OpenFlow networks, Software Defined Networks, etc.).

### BACKGROUND OF THE INVENTION

Software defined networks are gaining momentum in defining next generation core, edge, and data center networks. For carrier grade operations (e.g., high availability, fast connectivity, scalability), it is critical to support multiple controllers in a wide area network. In light of the outages observed in recent earthquake and after smart phones are introduced into the network as a fully connected and physically functioning part of the network, there should be extreme caution against faults and errors in the control plane.

In various prior art networking scenarios (e.g., failover, load balancing, virtualization, multiple authorities), multiple controllers are needed to run a forwarding plane. The forwarding plane is divided into different domains, each of which is assigned to a distinct controller. Inter-controller communication is required to keep a consistent global view of the forwarding plane. When this inter-controller communication is interrupted or slow, each controller might want to verify topology connectivity and routes without relying on the inter-controller communication, but instead relying on the preinstalled rules on the forwarding plane.

In other prior art networking scenarios, a single controller can be in charge of the entire forwarding plane, but due to failures (e.g., configuration errors, overloaded interfaces, buggy implementation, hardware failures), the single controller can lose control of a portion of this forwarding plane. In such situations, a controller may rely on the preinstalled rules on the forwarding plane.

One set of existing solutions target fully functional but misbehaving forwarding elements, which might be due to forwarding rules that are installed yet not compliant to network policies or might be due to not executing the forwarding rules correctly. These works provide static checkers, programming languages, state verification tools, etc. to catch or prevent policy violations in a network with physically healthy nodes/interfaces that are still reachable and (re)programmable. Thus, they mostly solve an orthogonal problem. One of the existing works detects a malfunctioning forwarding element (e.g., switch or interface), but requires verification messages to be generated between end hosts treating the forwarding plane as a black box with input and output ports. As such, it does not provide mechanisms for controllers to detect lossy components as no verification rules are programmed on the switches.

Another set of existing works install default forwarding rules proactively to prevent overloading of the control network and the controller servers. These proactive rules might for instance direct all out-bound traffic to a default gateway, drop packets originated from and/or destined to unknown or unauthorized locations, etc. Note that having a default forwarding path does not mean there are mechanisms for a controller to verify that the path is still usable or not.

Another related work is about topology discovery. Network controllers inject broadcast packets to each switch which are flooded over all switch ports. As the next hop switch passes these packets to the network controller, the controller deduces all the links between the switches. When the control network is partitioned, the controller cannot inject or receive packets from the switches that are not in the same partition as the controller. Thus, the health of links between those switches cannot be verified by such a brute-force approach.

Yet another set of relevant works appear in all-optical networks, where fault diagnosis (or failure detection) is done by using monitoring trails (m-trails). An m-trail is a pre-configured optical path. Supervisory optical signals are launched at the starting node of an m-trail and a monitor is attached to the ending node. When the monitor fails to receive the supervisory signal, it detects that some link(s) along the trail has failed. The objective is to design a set of m-trails with minimum cost such that all link failures up to a certain level can be uniquely identified. Monitor locations are not known a priori and identifying link failures is dependent on where the monitors are placed. Note also that in all-optical networks, there is a per link cost measured by the sum bandwidth usage of all m-trails traversing that link.

There are also works on graph-constrained group testing that is very similar to fault diagnosis in all-optical networks, and share the same fundamental differences.

### SUMMARY OF THE INVENTION

A method and apparatus are disclosed herein for topology and/or path verification in networks. In one embodiment, a method is disclosed for use with a pre-determined subset of network flows for a communication network, where the network comprises a control plane, a forwarding plane, and one or more controllers. The method comprises installing forwarding rules on the forwarding elements for identification of network information, wherein the forwarding rules are grouped into one or more separate control flows, where each of the one or more control flows makes a closed loop walk through at least a portion of the network according to the forwarding rules of said each control flow, injecting traffic for one or more control flows onto the forwarding plane, and identifying the network information based on results of injecting the traffic.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1A is a block diagram of one embodiment of a communication network infrastructure.

FIGS. 1B-1D show an alternative view of the network of FIG. 1A.

FIG. 2 shows a case where a single interface malfunctions on the control plane leading to two partitions.

FIG. 3 illustrates a scenario where there is a partition in the control plane and link failures in the forwarding plane.

FIG. 4 depicts the situation in which, in the face of a failure scenario specified in FIG. 3, the controller verifies whether a network flow can be still routed or not.

FIG. 5 illustrates one embodiment of a sequence of signaling that occurs to install forwarding rules for the control flows.

FIG. 6 is an example of an adjacency graph for the forwarding plane topology.

FIG. 7 illustrates an example of such a cycle for the example topology in the previous stages.

FIGS. 8A and B are flow diagrams depicting one embodiment of a method to compute the walk and translate it onto forwarding rules which in return are installed onto the switches on the forwarding plane.

FIGS. 9A and B are flow diagrams depicting one embodiment of a process for determining which forwarding rules should be installed on which switches (i.e., the set up stage) as well as locating failure locations (i.e., the detection stage).

FIG. 10 provides the result of a recursive splitting.

FIG. 11 shows an example of an undirected graph representation for the forwarding plane shown in FIGS. 1B-1D.

FIG. 12 is a flow diagram of a process for constructing a virtual ring topology using the graph such as shown in FIG. 11 as the starting point.

FIG. 13 shows a new minimal graph that is constructed using the process of FIG. 12.

FIG. 14 shows one possible Euler cycle and the logical ring topology.

FIG. 15 is a flow diagram of one embodiment of a process for topology verification.

FIG. 16 shows the case where controllers inject control packets onto the logical ring topology using a forwarding element in their corresponding control domains.

FIG. 17 illustrates an example of a graph for the forwarding plane shown in FIG. 1B.

FIG. 18 is a flow diagram of another process for constructing a virtual ring topology

FIG. 19 is a flow diagram of one embodiment of a process for computing a set of static forwarding rules used to locate an arbitrary link failure.

FIG. 20 shows an example for the topology given in FIG. 1B-1D assuming the undirected graph in FIG. 11.

FIG. 21 depicts the case where bounce back rules are used for both clockwise and counter clockwise walks.

FIG. 22 is a flow diagram of one embodiment of a process for performing a binary search.

FIGS. 23-25 show the three iterations of the binary search mechanism outlined in FIG. 22 over the ring topology example used so far.

FIG. 26 depicts the updated binary search.

FIGS. 27-29 illustrate the same failure scenario as before over the search in FIG. 26.

FIG. 30 depicts a block diagram of a system.

### DETAILED DESCRIPTION OF THE PRESENT INVENTION

Embodiments of the invention provide partition and fault tolerance in software defined networks (SDNs). A network controller which has only partial visibility and control of the forwarding elements and the network topology can deduce which edges, nodes or paths are no longer usable by using a small number of verification rules installed as forwarding rules in different forwarding elements (e.g., switches, routers, etc.) before the partitions and faults.

Embodiments of the present invention overcome failures and outages that occur in any large scale distributed systems due to various elements, such as, for example, but not limited to, malfunctioning hardware, software bugs, configuration errors, and unanticipated sequence of events. In software defined networks where the forwarding behavior of the network and dynamic routing decisions are dictated by external network controllers, such outages between the forwarding elements and controllers result in instantaneous (e.g., due to a switch or link going down along the installed forwarding paths) or eventual (e.g., forwarding rule is timed out and deleted) loss of connectivity on the data plane although there is an actually functioning physical connectivity between ingress and egress points of the forwarding plane. Problems that prevent availability are identified and/or solved by embodiments of the invention include, but are not limited to: (i) lack of visibility of errors in the forwarding plane by the controller and (ii) lack of control over the failed forwarding elements. Embodiments of the invention, by properly setting up a minimal number of verification, rules can bring visibility on the failure events and allow discovering functioning paths.

Embodiments of the invention include mechanisms for a network controller with partial control over a given forwarding plane to verify the connectivity of the whole forwarding plane. By this way, the controller does not need to communicate with other controllers for verifying critical connectivity information of the whole forwarding plane and can make routing or traffic engineering decisions based on its own verification.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

Embodiments of the invention relate to multiple network controllers that control the forwarding tables/states and per flow actions on each switch on the data plane (e.g., network elements that carry user traffic/payload). Although these switches are referred to as OpenFlow switches herein, embodiments of the invention apply to forwarding elements that can be remotely programmed on a per flow basis. The network controllers and the switches they control are interconnected through a control network. Controllers communicate with each other and with the OpenFlow switches by accessing this control network.

In one embodiment, the control network comprises dedicated physical ports and nodes such as dedicated ports on controllers and OpenFlow switches, dedicated control network switches that only carry the control (also referred to as signaling) traffic, and dedicated cables that interconnect the aforementioned dedicated ports and switches to each other. This set up is referred to as an out-of-band control network. In one embodiment, the control network also shares physical resources with the data plane nodes where an OpenFlow switch uses the same port and links both for part of the control network as well as the data plane. Such set up is referred to as in-band control network.

Regardless of whether the control network follows out-of-band, in-band or a mixture of both, it is composed of separate interfaces, network stack, and software components. Thus, both physical hardware failures and software failures can bring down control network nodes and links, leading to possible partitioning in the control plane. When such a partition occurs, each controller can have only a partial view of the overall data plane (equivalently forwarding plane) topology with no precise knowledge on whether the paths it computes and pushes to switches under its control are still feasible or not.

Embodiments of the invention enable controllers to check whether the forwarding plane is still intact (i.e., all the links are usable) or not, whether the default forwarding rules and tunnels are still usable or not, and which portions of the forwarding plane is no longer usable (i.e., in outage). In one embodiment, this is done by pushing a set of verification rules to individual switches (possibly with the assistance of other controllers) that are tied to a limited number of control packets that can be injected by the controller. These verification rules have no expiration date and have strict priority (i.e., they stay on the OpenFlow Switches until they are explicitly deleted or overwritten). When a controller detects that it cannot reach some of its switches and/or other controllers, it goes into a verification stage and injects these well specified control packets (i.e., their header fields are determined apriori according to the verification rules that were pushed to the switches). The controller, based on the responses and lack of responses to these control packets, can determine which paths, tunnels, and portions of the forwarding topology are still usable.

SDNs are emerging as a principal component of future IT, ISP, and telco infrastructures. It promises to change networks from a collection of independent autonomous boxes to a well-managed, flexible, multi-tenant trans-port fabric. As core principles, SDNs (i) de-couple the forwarding and control plane, (ii) provide well-defined forwarding abstractions (e.g., pipeline of flow tables), (iii) present standard programmatic interfaces to these abstractions (e.g., OpenFlow), and (iv) expose high level abstractions (e.g., VLAN, topology graph, etc.) as well as interfaces to these service layer abstractions (e.g., access control, path control, etc.).

Network controllers that are in charge of a given forwarding plane must know (ii) and implement items (iii) and (iv), accordingly.

To fulfill its promise to convert the network to a well-managed fabric, presumably, a logically centralized network controller is in charge of the whole forwarding plane in an end-to-end fashion with a global oversight of the forwarding elements and their inter-connections (i.e., nodes and links of the forwarding topology) on that plane. However, this might not be always true. For instance, there might be failures (software/hardware failures, buggy code, configuration mistakes, management plane overload, etc.) that disrupt the communication between the controller and a strict subset of forwarding elements. In another interesting case, the forwarding plane might be composed of multiple administrative domains under the foresight of distinct controllers. If controller of a given domain fails to respond or has very poor monitoring and reporting, then the other controllers might have a stale view of the overall network topology leading to suboptimal or infeasible routing decisions.

Even when a controller does not have (never had or lost) control of a big portion of the forwarding plane, as long as it can connect and control at least one switch, it can inject packets into the forwarding plane. Thus, given a topology, a set of static forwarding rules can be installed on the forwarding plane to answer policy or connectivity questions. When a probe packet is injected, it traverses the forwarding plane according to these pre-installed rules and either returns back to the sending controller or gets dropped. In either case, based on the responses and lack of responses to its probes, the controller can verify whether the policies or topology connectivity is still valid or not, where they are violated, and act accordingly. In one embodiment, the controller dynamically installs new forwarding rules for the portions of the forwarding plane under its control. Therefore, static rules can be combined with dynamic rules to answer various policy or connectivity questions about the entire forwarding plane.

Embodiments of the invention relates to the installation or programming of control flow rules into the forwarding plane such that when a controller cannot observe a portion of the forwarding plane, it can make use of these control flows to run diagnostics in order to discover connected and disconnected parts of the forwarding plane as well as routable and non-routable network flows. Techniques for computing static forwarding table rules for verifying topology connectivity and detecting single link failures in an optimal fashion are disclosed. Also disclosed are techniques for multiple link failure detection.

Embodiments of the present invention include techniques for computing static rules such that (1) the topology connectivity of the whole forwarding plane can be verified by using minimum number of forwarding rules and control messages and (2) single link failures can be located by using a (small) constant number of forwarding rules per forwarding element. Using these methods, any network controller that has access to at least one forwarding element can install one or more dynamic rules, inject control packets that are processed according to the static rules computed by the disclosed methods, and these control packets then are looped back to the controller (if every switch and link along the path functions correctly) using the dynamic rule(s) installed by that controller.

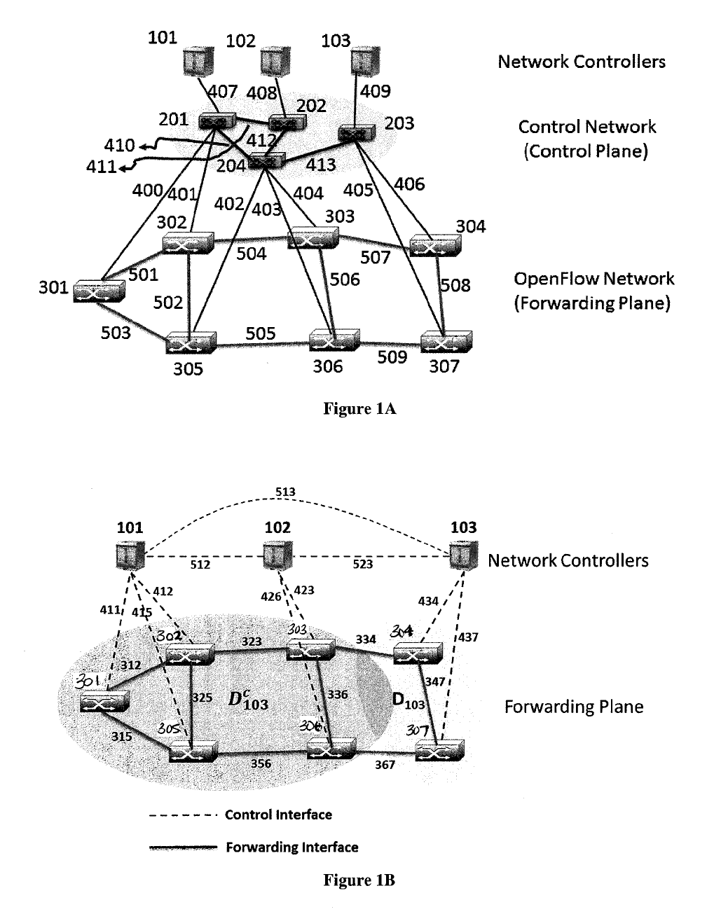

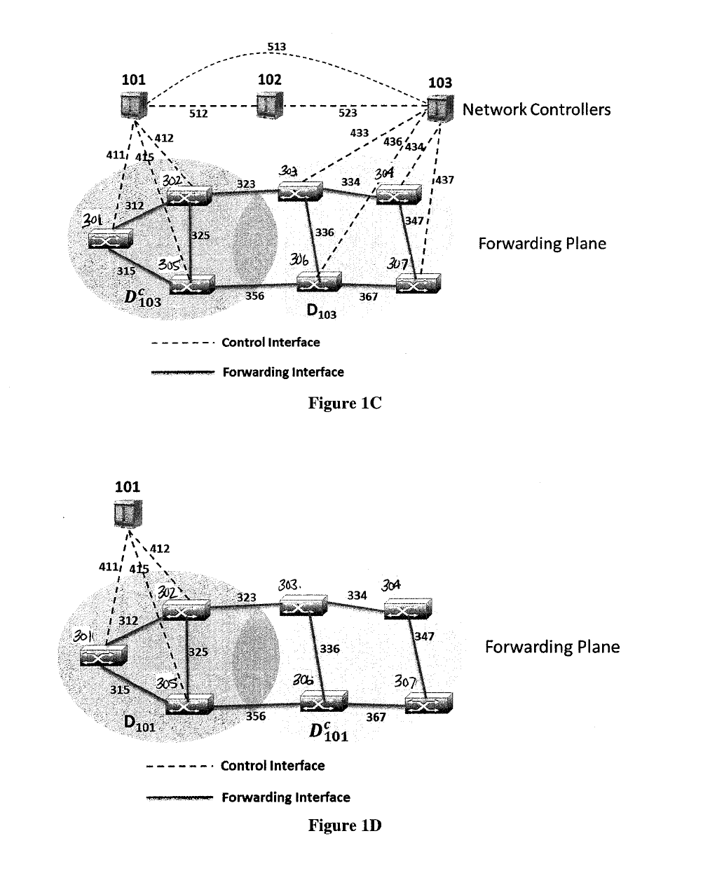

FIG. 1A is a block diagram of one embodiment of a communication network infrastructure where forwarding paths are determined and programmed by a set of network controllers, whereas the forwarding actions are executed by a set of forwarding elements (e.g., switches, routers, etc.). In one embodiment, forwarding elements comprise OpenFlow capable switches 301-307. The forwarding plane constitutes all the forwarding elements 301-307 and the links 501-509 between these forwarding elements 301-307. Each of forwarding elements 301-307, upon receiving a packet in an incoming port, makes use of one or more forwarding tables to determine whether the packet must be modified in any fashion, whether any internal state (e.g., packet counters) must be modified, and whether packet must be forwarded to an outgoing port. In one embodiment, forwarding elements inspect incoming packets using their L1 (physical layer) to L4 (transport layer) or even to L7 (application layer) information, search for any match to forwarding rules installed on its programmable (hardware or software) forwarding tables, and take necessary actions (e.g., rewrite packet headers or even payload, push/pop labels, tag packets, drop packets, forward packets to an outgoing logical/physical port, etc.). In one embodiment, the matching rules and the actions to be taken for each matching rule are programmed by external entities called network controllers 101-103.

Network controllers 101-103 and forwarding elements 301-307 communicate with each other through control interfaces and links 411, 412, 421, 422, 423, 441, 442, which for instance can be a TCP or SSH connection established between a forwarding element and a controller over a control network. Network controllers 101-103 and forwarding elements 301-307 also communicate with each other through as hardware/software switches (201 through 204 in FIG. 1A).

In one embodiment, these interfaces, links, and switches on the control plane are collocated with forwarding plane elements on the same physical machines. In another embodiment, they correspond to physically separate elements. Yet, in another embodiment, it can be mixed, i.e., some control plane and forwarding plane elements are physically collocated, whereas others are not. Network controllers in one network embodiment are physically separate than the control network and the data network (i.e., forwarding plane). But, the problem being solved by embodiments of the invention are also applicable even if some or all network controllers are hosted on the control plane or forwarding plane nodes (e.g., switches and routers).

In one network embodiment, each forwarding element 301-307 is controlled by a master controller and a forwarding element cannot have more than one master at any given time. In one embodiment, only the master is allowed to install forwarding table rules and actions on that element. Network controllers 101-103 either autonomously or using an off-band configuration decide which controller is master for which forwarding elements. The master roles can change over time due to load variations on the forwarding and control planes, failures, maintenance, etc.

FIG. 1B shows an alternative view of the network of FIG. 1A with forwarding elements are assumed to be OpenFlow capable switches (301 through 307). As discussed above with respect to FIG. 1A, network controllers 101-103 and forwarding elements 301-307 communicate with each other through control interfaces and links (411, 412, 421, 422, 423, 441, 442), but network controllers 101-103 can also communicate with each other through separate control interfaces (512, 513, 523 in FIG. 1B). These control interfaces between the controllers can be used for state synchronization among controllers, to indirect requests from the forwarding plane to the right controller, to request installation of forwarding rules under control of other controllers, or any other services available on other controllers. The technologies described herein apply equally to a set up where control network is hosted on a different set of physical switches and wires or partially/fully collocated with the forwarding plane but have logical isolation with or without resource isolation.

In different scenarios, the control of forwarding plane can be divided among controllers. An example of this is depicted in FIG. 1B, forwarding elements (FEs) 301, 302, 305 belong to controller 101, FEs 303 & 306 belong to controller 102, and FEs 304 & 307 belong to controller 103. For purposes herein, the control domain of a given controller x is referred to by Dx and any forwarding elements outside the control domain of x by Dₓ^{C}. i.e., according to FIG. 1B, D103 consists of {304, 307} and D₁₀₃^{C} consists of {301, 302, 303, 305, 306}.

In one embodiment, each controller is in charge of its autonomous domain, where intra-domain routing is dictated by each domain's controller while inter-domain routing is governed by inter-controller coordination and communication. In this case, switches are only aware of their own domain controller(s). Controllers share their local topologies with each other to construct a global topology and coordinate end to end route computation. In cases when the communication and state synchronization between the controllers are impaired (due to hardware/software failures, interface congestion, processing overload, etc.), the topology changes (e.g., link failures) in one controller's domain may not be communicated on time to other controllers. This may adversely impact the routing and policy decisions taken by the other controllers. Thus, it is imperative to provide solutions where a controller can verify the forwarding plane properties without relying only on the other controllers.

In another embodiment, for load balancing purposes, distinct subsets of forwarding elements can be communicated with distinct controllers. The load balancing policy could be decided and dictated by a separate management plane (not shown to avoid obscuring the invention). In this case, each controller only monitors and programs its own set of forwarding elements, thusly sharing the load of monitoring and programming the network among multiple controllers. Depending on the load balancing policies, the manner in which switches are mapped to different controllers can vary over time. For instance, for the forwarding plane depicted in FIG. 1B and FIG. 1C, controller 103 has in one epoch D103={304, 307} and in another epoch D103={303, 304, 306, 307}. This decision can be done according to the control traffic generated by different forwarding elements. Even in this load balancing scenario, controllers would like to share a global view of topology that is consistently maintained, e.g., a link failure detected by a controller in its own control domain must update the global topology view by passing messages to other controllers over the controller to controller interfaces (512, 513, 523 in FIG. 1B) or by updating a database that can be accessed by all controllers. Similar to the case in multiple autonomous domains, any impairment or failure of reporting by a controller would lead to a (possibly consistent) but stale state about the forwarding plane. Thus, it is also important in this case to have controllers verify the forwarding plane in a fast and low overhead fashion without relying on inter-controller state synchronization.

Yet, in another embodiment, there can be in reality a single controller in charge of the whole domain with other controllers acting as hot standby. When a single controller is in charge, it can lose some of the control interfaces to a subset of forwarding elements as depicted in FIG. 1D. Controller 101 has D101={301, 302, 305}, and therefore cannot communicate/monitor directly the forwarding elements in D₁₀₁^{C}={303, 304, 306, 307}. Controller 101 in this embodiment has no other controller to rely on to update its view on D₁₀₁^{C}, and thus sends control probes into the forwarding plane and listen to the responses.

Diagnostics and Obtaining Information about a Network

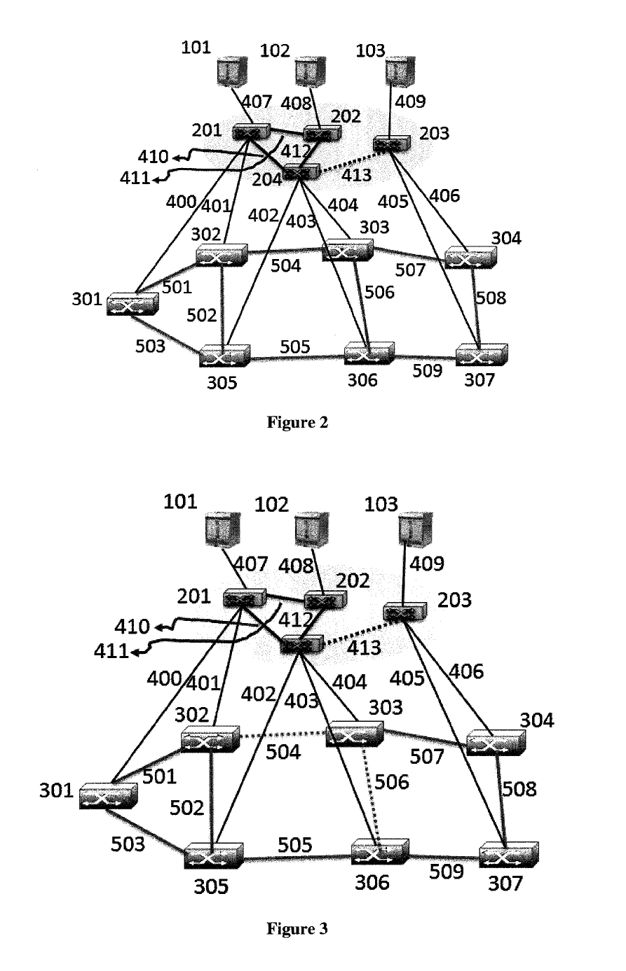

Any malfunction that might stem from software/hardware bugs, overloading, physical failures, configuration mistakes, etc. on the control network can create partitions where only the elements in the same partition can communicate with each other. FIG. 2 shows a case where a single interface malfunctions 413 on the control plane leading to two partitions: the first partition is {101, 102, 201, 202, 204, 301, 302, 303, 305, 306} and the second partition is {103, 203, 304, 307}. In this example, controllers 101 and 102 can communicate with each other and send instructions to forwarding elements 301, 302, 303, 305, and 306, but they cannot communicate with 103, 304, and 307. Similarly, controller 103 can only reach to forwarding nodes 304 and 307, but not to the other controllers and switches. In such a scenario, controller 103 has only partial topology visibility and cannot be sure whether the rest of the topology is intact or whether the previously set up routing paths are still usable. In one embodiment, since most routing paths are established with an expiration time, even in cases where the forwarding topology is intact, the forwarding rules might be no longer valid. Since controller 103 cannot reach the elements in the first partition, it cannot reinstall or refresh routing rules on forwarding elements 301, 302, 303, 305, and 306 directly (as the master controller) or indirectly (through negotiating with other controllers who are the masters). However if the forwarding plane is fully or partly functioning, then controller 103 can inject control flows into the forwarding plane through the forwarding elements it can reach and wait for responses generated in reaction to these control flows. By doing this, controller 103 can learn whether the forwarding plane is a connected topology or not, whether the default paths/tunnels are still usable or not, and if there is a link failure, which link has failed.

Thus, in one embodiment of the invention, control flow rules are installed and programmed into the forwarding plane such that a controller that cannot observe a portion of the forwarding plane can make use of these control flows to run diagnostics in order to discover connected and disconnected parts of the forwarding plane as well as routable and non-routable network flows.

FIG. 3 illustrates a scenario where in addition to the partition in the control plane there are link failures in the forwarding plane. Referring to FIG. 3, controller 103 has no reachability to any of the end points of failed links 504 and 506. Therefore, controller 103 would not receive any signals from switches 303, 302, or 306 to report these link failures even if those switches were capable of detecting them. Unless the forwarding plane has a topology discovery solution running autonomously on all switches and the switches disseminate topology changes (e.g., link/node additions, failures, removals) to other switches, switches 304 and 307 cannot detect link failures 504 and 506 as they are not directly connected to them. Therefore, controller 103 cannot also receive any notification for these failures from switches in its own partition (that includes switches 304 and 307).

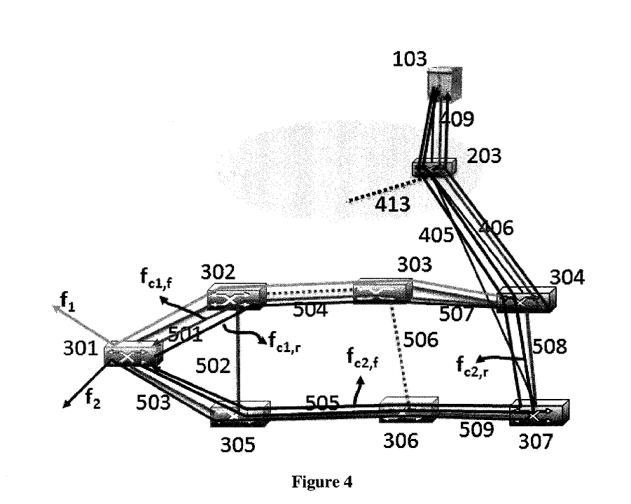

FIG. 4 depicts the situation in which, in the face of a failure scenario specified in FIG. 3, one embodiment of the controller verifies whether a network flow can be still routed or not. A network flow for purposes herein should be understood broadly as a bit-mask with zero, one, and don't care values applied to some concatenation of header fields in a packet. All the packets with an exact match to ones and zeros as defined in the bit-mask belong to the same flow and they would be routed in exactly the same fashion (i.e., flow-based routing). The headers can include, but are not limited to, MPLS labels, VLAN tags, source & destination MAC addresses, source & destination IP addresses, protocol names, TCP/UDP ports, GTP tunnel identifiers, etc. In one embodiment, a set of default flows are defined and routing rules for them are proactively pushed with very long expiration times or even with no expiration (i.e., they are used until explicitly removed or overwritten). In FIG. 4, two flows labeled as f₁ and f₂ are examples of such default flows. In a legacy set up, these flows can correspond to MPLS flows routed according to their flow labels. Flow f₁ has its ingress forwarding element as 304 and is routed through switches 303 and 302 before finally exiting the network at egress forwarding element 301. Similarly, flow f₂ has its ingress forwarding element as 307 and is routed through switches 306 and 305 before finally exiting the network at egress forwarding element 301. In one embodiment, a pair of control flows is set up for each flow to be monitored, one in the forward direction and one in the reverse direction (opposite direction). In FIG. 4, f_{c1,f} and f_{c1,r} are the pair of control flows for f₁, whereas f_{c2,f} and f_{c2,r} are the pair of control flows for f₂. Note that one can also view these pair of control flows as a single flow if their bit-mask used for routing are the same. For illustration purposes, control flows are labeled in a forward direction (the same direction as the monitored flow) and in a reverse direction (the feedback direction towards the controller) as separate and pair them instead. The control flow in the forward direction (e.g., f_{c1,f}) must be routed/processed by the same sequence of forwarding elements as the monitored flow (e.g., f₁). In one embodiment, control flows in the forward direction follow the monitored flow. Specifically, if monitored flow is re-routed over a different path (i.e., sequence of forwarding elements), then its control flow in the forward direction also is re-routed to the new path. If the monitored flow expires, then the control flow in the forward direction also expires. One difference between the monitored flow and the control flow in this embodiment is that the monitored flow is strictly forwarded in the forwarding plane with no controller on its path and the traffic for the monitored flow is generated by actual network users. On the other hand, the control flows are solely used by the controller and the paths originate and/or terminate at the controller and get passed in parts through the control network.

To monitor the health of the path for the monitored flow, the controller injects traffic for the control flows of that monitored flow. The traffic injection in the case of an OpenFlow network amounts to generating an OFPT_PACKET_OUT message towards an OpenFlow switch and specifying the incoming port on that switch (or equivalently the link) for the control flow packet encapsulated in the OFPT_PACKET_OUT message. One difference between the monitored flow and its control flows would be a few additional bits set in the bit-mask of the control flow that correspond to “don't care” fields of the monitored flow. For instance, if the monitored flow is specified by its MPLS label, the control flows might be using MAC address fields in addition to the MPLS label. In terms of forwarding table entries, the forward control flow does not insert a new forwarding rule/action until the egress router. In other words, the forwarding rules set for the monitored flow would be used for matching and routing the forward control flow. Such an implementation handles the re-routing and expiration events since as soon as the forwarding rules for the monitored flow are changed, they immediately impact the forward control flow.

In FIG. 4, control flow f_{c1,f} uses the same flow table rules and processed in the same pipeline as f₁ on switches 304, 303, and 302. When control flow f_{c1,f} reaches switch 301, it cannot use the same flow table rule as flow f₁ since it would then exit the network. Instead, on switch 301, a more specific forwarding rule that exactly matches the bit-mask of control flow f_{c1,f} is installed. The action for this bit-bask reverses the direction of the flow. In fact, control flow f_{c1,r} is routed exactly following the reverse path of control flow f_{c1,f}. Each switch along the reverse path has a matching rule that exactly matches the bit-mask of control flow f_{c1,f} plus the incoming switch port along the reverse path. When the control flow packet reaches switch 304, it has a forwarding action that pushes a control message to controller 103. In the case of OpenFlow network, switch 304 generates an OFPT_PACKET_IN message to be sent to controller 103. This way, the loop is closed and controller 103 receives the traffic it injected for a particular control flow back if and only if all the switches and links along the path of monitored flow are healthy and forwarding rules/routes for the monitored flow are still valid and functional. Therefore, if controller 103 does not receive the injected packets back then a failure for a default path has potentially occurred.

In another embodiment, the controller sets up many default paths with minimal or no sharing of the same links and switches. Each default path is accompanied by its control flow. The controller maintains an active list of default paths that are still functional. When a partition event is detected by the controller, the controller injects traffic for these control flows of distinct default paths. If packets for a subset of control flows are not received back, the corresponding default paths can be removed from the active list and put on an outage list. For the control flows of which packets are received by the controller, the corresponding default paths remain in the active list and the controller instructs the ingress switch to use the default paths in the active list only. In one embodiment, for instance, if default paths correspond to tunnels, label switched paths, or circuits, the flow table actions at the ingress router can be rewritten such that the incoming flows are mapped only onto tunnels, labels, or circuits in the active list. In FIG. 4, controller 103 detects that flow f₁ is no longer routed (due to the failure of links 504 and 506, although these failures themselves are not known by the controller) whereas f₂ is still routable. Thus, for every flow reaching forwarding 304 as the ingress switch, controller 103 instructs 304 to swap the bit-mask of these flows with flow f₂ as the first action in the processing pipeline before the routing action.

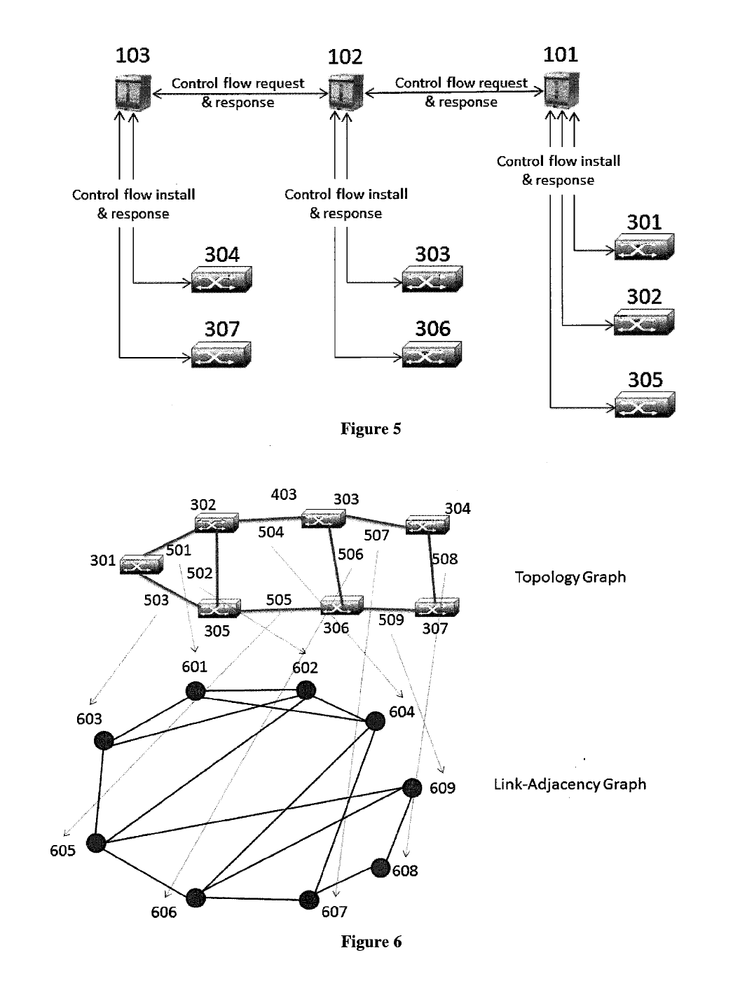

FIG. 5 illustrates one embodiment of a sequence of signaling that happens to install forwarding rules for the control flows. In one embodiment, controller 101 is the master controller for forwarding elements 301, 302, and 305; controller 102 is the master for 303 and 306; and controller 103 is the master for 304 and 307. To install match and action rules for f_{c1,r}, controller 103 communicates with controller 101 to install rules on forwarding elements 301 and 302, with controller 102 to install rules on forwarding element 303, and with forwarding element 304 directly to generate the control plane packet.

Besides checking the health of specific flows, techniques are described herein to identify the overall topology connectivity and detect single link failures. For such diagnosis, controllers also install control flows on the forwarding plane, inject control packets for these flows, and based on the responses (or lack of them) draw conclusions.

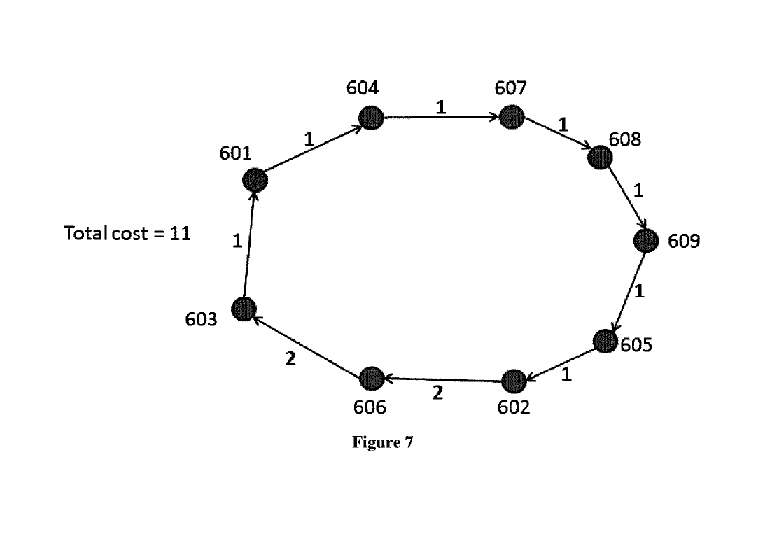

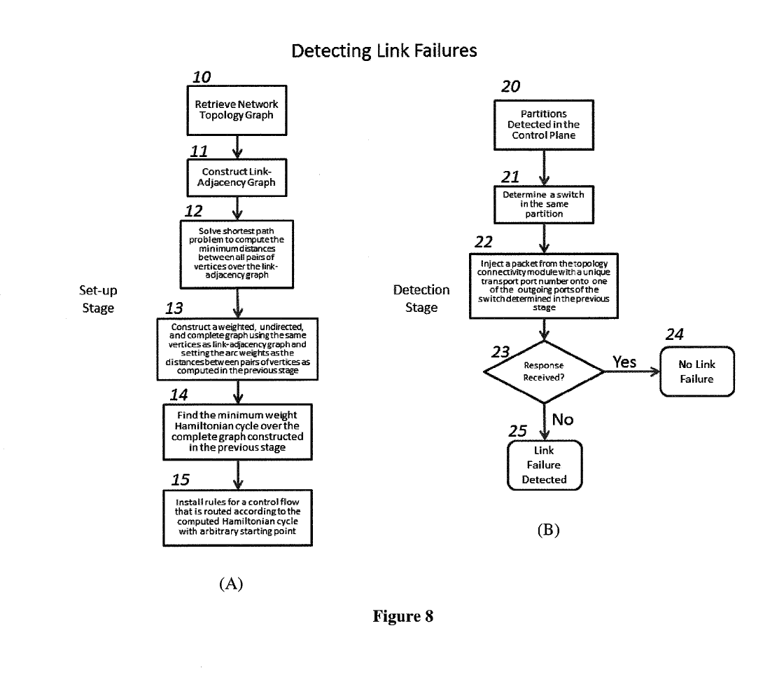

In one embodiment, controller can verify topology connectivity (i.e., any link failures—note that if a switch itself fails there will translate into link failures) by installing a control flow that makes a sequence of walks covering all the links on the forwarding plane. Embodiments of the invention include a particular method to compute the walk and translate it onto forwarding rules which in return are installed onto the switches on the forwarding plane. FIGS. 8A and B are flow diagrams depicting one embodiment of this process. FIGS. 6 and 7 as well as Table 1 are illustrative example of different operations by using the network topology shown in FIG. 1A.

Referring to FIG. 8A, the process is performed by processing logic that may comprise hardware (circuitry, dedicated logic, etc.), software (such as is run on a general purpose computer system or a dedicated machine), firmware, or a combination of these three. The process begins by performing topology discovery (processing block 10). In one embodiment, the topology discovery amounts to identifying all the forwarding elements and their interconnections by the network controllers. There are well-known solutions to perform this operation. For instance in OpenFlow networks, whenever a switch joins the network, it advertises itself to preconfigured network controllers with the switch port information. The controller can inject ICMP packets and flood all outgoing interfaces of all switches, which are then sent to the controller by the next hop switch as the default policy. Any particular method including this one can be used to realize topology discovery operation.

Next, processing logic constructs a link-adjacency graph by denoting each link in the network topology as a vertex in this graph (processing block 11). In this case, in one embodiment, there is an arc between two vertices on this graph if and only if the corresponding two links can be traversed consecutively (i.e., 1 switch apart). Note that the example is for bidirectional links, but it is trivial to extend the method to directional links by simply counting each direction as a separate link. FIG. 6 draws the adjacency graph for the forwarding plane topology. In FIG. 6, for instance, link 503 is mapped to node 603 on the adjacency graph.

After constructing the link-adjacency graph, processing logic computes shortest paths between any pairs of vertices on the adjacency graph and creates a table that stores the distance information as shown in Table 1 (processing block 12). This solves the shortest path problem to compute the minimum distances between all pairs of vertices over the link-adjacency graph. In one embodiment, shortest paths are computed by applying Dijkstra's algorithm. In one embodiment, the distance here refers to the minimum number of switches that need to be crossed to reach from one link to another. Since each switch installs exactly one forwarding rule for such reachability, this translates into minimum number of forwarding rules that needs to be installed on the forwarding plane.

Next, processing logic forms a complete undirected graph using the same vertices as the link adjacency graph but by drawing an arc with a weight (processing block 13). The arc weight equals to the minimum distance between the two vertices in connects. For example, the arc between vertices 604 and 609 has a weight of two as can be seen in Table 1. That is, processing logic constructs a weighted, undirected and complete graph using the same values as the link-adjacency graph, with the arc weights set as the distances between pairs of vertices as computed above.

Then, processing logic computes the shortest Hamiltonian cycle on the complete undirected graph constructed in processing block 13. A Hamiltonian cycle traverses all the vertices of the graph exactly once and comes back to the starting point. An example of such a cycle for the example topology illustrated in the previous stages is shown in FIG. 7. The total cost of this cycle amounts to 11 unique visits to 7 switches. In other words, 11 total forwarding rules need to be on the forwarding plane and a switch is allowed to be visited multiple times, thereby requiring multiple forwarding rules to be installed. In one embodiment, the objective is to minimize the number of forwarding rules, thus computing the minimum cost Hamiltonian cycle is required. Searching for minimum Hamiltonian cycle over arbitrary graphs is an NP-complete problem. One method uses any well-known heuristic solution. In another embodiment, any Hamiltonian cycle might be acceptable as long as the upper-bound on total cost is reasonable. In one embodiment, the upper-bound on the total cost is reasonable if per switch overhead is less than 3% of the total number of supportable hardware forwarding rules per switch. A trivial upper-bound in this case would be given by the product of number links and the maximum distance between pairs of links. According to Table 1 constructed for the forwarding plane example drawn in FIG. 1A, this upper bound becomes 9×3=27. A greedy heuristic is provided here for illustration purposes. One can start from an empty list and then add an arbitrary vertex. The next element added to the list is the vertex not in the list and closest to the last element of the list. If multiple candidates have the same distance, then an arbitrary one is selected. When all the vertices are added to the list, the first vertex in the list is added to the end of the same list. This gives a simple heuristic construction of a Hamiltonian cycle on a complete graph. One can also do a branch and bound heuristic where different candidate vertices are added to create multiple lists and the lists with a lower total (or average) cost are investigated before the lists with higher total (or average) costs.

Lastly, processing logic generates forwarding rules according to the computed Hamiltonian cycle. One can design the rules such that network controller can inject control flow traffic to any forwarding element. In one embodiment, the controller defines a unique control flow to check the topology connectivity, e.g., use a unique transport layer port number (e.g., UDP port) and controller MAC address to match the fields {source MAC address, transport layer port number}. A rule can be installed on every switch that matches the incoming switch port (i.e., link/interface) and this unique control flow. The action specifies the outgoing switch port (i.e., link/interface) to which the control flow packet is sent. If the computed Hamiltonian cycle does not traverse the same switch on the same incoming interface more than once, then such matching is sufficient. However, this is not always the case. To clarify this, consider the Hamiltonian cycle in FIG. 7 and suppose traversing starts from vertex 604. Thus, the vertices are visited in the following order 604, 607, 608, 609, 605, 602, 606, 603, 601, 604 over the link adjacency graph. This is equivalent to visiting links in the following order 504, 507, 508, 509, 505, 502, 506, 503, 501, 504. Since 502 to 506 cannot be reached directly, switch 302, link 504, and switch 303 need to be crossed. Similarly, 506 to 503 cannot be reached directly, and thus switch 306, link 505, and switch 305 need to be crossed. The overall walk as a sequence of links and switches then becomes: 504, 303, 507, 304, 508, 307, 509, 306, 505, 305, 502, 302, 504, 303, 506, 306, 505, 305, 503, 301, 501, and 302. Controller can ask switch 302 to inject a control packet onto link 504. When switch 302 receives the same packet from link 501, it can package it and send to the originating controller. As can be seen easily from the walk, switch 303 receives the control flow packet twice from the same incoming port (end point of link 504). In the first time, it must forward the control packet towards link 507 and in the second time around it must forward the control flow packet towards link 506. A similar phenomenon occurs for switch 305, which must process the same control packet incoming from the same link (505). Setting of forwarding rules by only using source MAC address and transport layer port number is not sufficient to handle these cases. In one embodiment, to cover such cases, controller can install multiple matching rules for the same control flow by setting a separate field that can annotate each pass uniquely. For instance, switch 305 is traversed once to reach from link 505 to 502 (in the Hamiltonian cycle 605 to 602) and once to reach from 506 to 503 (in the Hamiltonian cycle 606 to 603).

If each jump on the Hamiltonian cycle is identified uniquely with the starting link and the ending link, then each pass can be annotated uniquely. Suppose controller 101 uses distinct VLAN id to annotate each arc in the Hamiltonian cycle and installs matching rules for these distinct VLAN ids in addition to the control flow fields used by the controller to uniquely identify that the control flow is for checking topology connectivity (e.g., {source MAC address, transport layer port number}, {mac101, udp1}). In one embodiment, the following match and action rules for this control flow packet are used to traverse the Hamiltonian cycle provided that no link or switch failures present in the forwarding plane:

TABLE 1

| Switch Name | Match | Action |
|---|---|---|
| 301 | {source MAC address, destination UDP, | Set VLAN id = v1 |
| | VLAN id} = {mac101, udp1, v3} | Send to link 501 |
| 302 | {source MAC address, destination UDP, | Set VLAN id = v4 |
| | VLAN id} = {mac101, udp1, v1} | Send to link 504 |
| 302 | {source MAC address, destination UDP, | Set VLAN id = v6 |
| | VLAN id} = {mac101, udp1, v2} | Send to link 504 |
| 303 | {source MAC address, destination UDP, | Set VLAN id = v7 |
| | VLAN id} = {mac101, udp1, v4} | Send to link 507 |
| 303 | {source MAC address, destination UDP, | Send to link 506 |
| | VLAN id} = {mac101, udp1, v6} | |
| 304 | {source MAC address, destination UDP, | Set VLAN id = v8 |
| | VLAN id} = {mac101, udp1, v7} | Send to link 508 |
| 305 | {source MAC address, destination UDP, | Set VLAN id = v2 |
| | VLAN id} = {mac101, udp1, v5} | Send to link 502 |
| 305 | {source MAC address, destination UDP, | Send to link 503 |
| | VLAN id} = {mac101, udp1, v3} | |
| 306 | {source MAC address, destination UDP, | Set VLAN id = v3 |
| | VLAN id} = {mac101, udp1, v6} | Send to link 505 |
| 306 | {source MAC address, destination UDP, | Set VLAN id = v5 |
| | VLAN id} = {mac101, udp1, v9} | Send to link 505 |
| 307 | {source MAC address, destination UDP, | Set VLAN id = v9 |
| | VLAN id} = {mac101, udp1, v8} | Send to link 509 |

When controller 101 generates a control flow packet with {source MAC address, transport layer port number, VLAN id}={mac101, udp1, v4} and injects it through switch 302 onto link 504, the following sequence of events occurs. Switch 303 receives it, finds a match and forwards it onto link 507 by setting VLAN id to v7. Switch 304 receives the packet, finds the match, sets VLAN id to v8 and sends to link 508. Switch 307 receives, finds the match, sets VLAN id to v9 and sends to link 509. Switch 306 receives, finds the match, sets VLAN id to v5, and sends to link 505. Switch 305 receives, finds the match, sets VLAN id to v2, and sends to link 502. Switch 302 receives, finds the match, sets VLAN id to v6, and sends to link 504. Switch 303 receives, finds the match, does not modify VLAN id, and sends to link 506. Switch 306 receives, finds the match, sets VLAN id to v3, and sends to link 505. Switch 305 receives, finds the match, keeps VLAN id the same, and sends to link 503. Switch 301 receives, finds the match, sets VLAN id to v1, and sends to link 501. Switch 302 receives, finds no match, as a default rule sends the packet to its master controller 101.

It might be the case that the default rule for no flow matches is to drop the packets. In such cases, in one embodiment, each switch is programmed by their master controller to send packets originated by the controller (e.g., by checking source mac address in this example) back to the controller if no other higher priority rule is specified. Note that in one embodiment, controller 101 can inject packets onto any link by specifying the right VLAN id. Thus, when partitions are detected, each controller can first identify the switches in the same partition and then use any of their outgoing links to inject the control flow packets. Note also that, in one embodiment, when the default rule for no matches is to forward to the master controller, one can wild card the source address for the controller (in the example the source MAC address)(e.g., the source address becomes “don't care” field). In such a case, we do not need to create separate rules for each controller. For cases, where the default action for flow misses is to drop the packets, the controller address is specified in the control packet and a forwarding rule is installed using the source address of its master controller at each switch. If during the sequence of packet forwarding events any link or switch fails, then controller would not receive that packet.

FIGS. 8A and B also disclose a process for detecting a link failure. The process in FIGS. 8A and B is performed by processing logic that may comprise hardware (circuitry, dedicated logic, etc.), software (such as is run on a general purpose computer system or a dedicated machine), firmware, or a combination of these three.

Referring to FIG. 8B, at processing block 20, processing logic in the controller detects partitions in the control plane. In the example given by FIG. 2, controller 103 can detect the partition when it does not receive heart beat messages or a response to its requests from other controllers. Processing logic in the controller determines which switches are in the same partition as the controller and selects one of them as the control flow injection point (processing block 21). In the example of FIG. 2, controller 103 identifies that it can still hear from switches 304 and 307, indicating that they are indeed in the same partition. Thus, using the preinstalled forwarding rules on switches 301 through 307 computed according to the Hamiltonion cycle shown in FIG. 7 (i.e., the rules are the same as above with matching source MAC address to mac address of 103, i.e., source MAC address=mac103), processing logic in controller 103 injects a packet on any link reachable from its partition (e.g., 507, 508, 509) and injects a packet with the corresponding VLAN id of that link. Thus, at processing block 22, processing logic in the controller injects a packet from its module that checks topology connectivity with a unique transport port number onto one of the outgoing ports of the switch selected in processing block 21.

Then, processing logic in the controller waits for the control flow packet to come back and checks whether it has received a response (processing block 23). The waiting time depends on the total link delays, but in most typical implementations it would be in the order of 100s of milliseconds or few seconds). If a response is received, processing logic in the controller concludes that a link failure has not occurred yet and routine terminates (processing block 24). If no response is received during waiting time, processing logic in the controller assumes that there is a link failure and lack of connectivity between some switches that are not observable by the controller directly (processing block 25). Clearly, in FIG. 2, the forwarding plane is intact and controller 103 receives the injected control packets back. On the other hand, in FIG. 3, due to the link failures, the traversal of the links would fail and lack of loop back packets would signal controller 103 that there are link failures. Note that it is a trivial matter to inject multiple packets for the same control flow at different times and look at the cumulative responses to make a decision on topology connectivity.

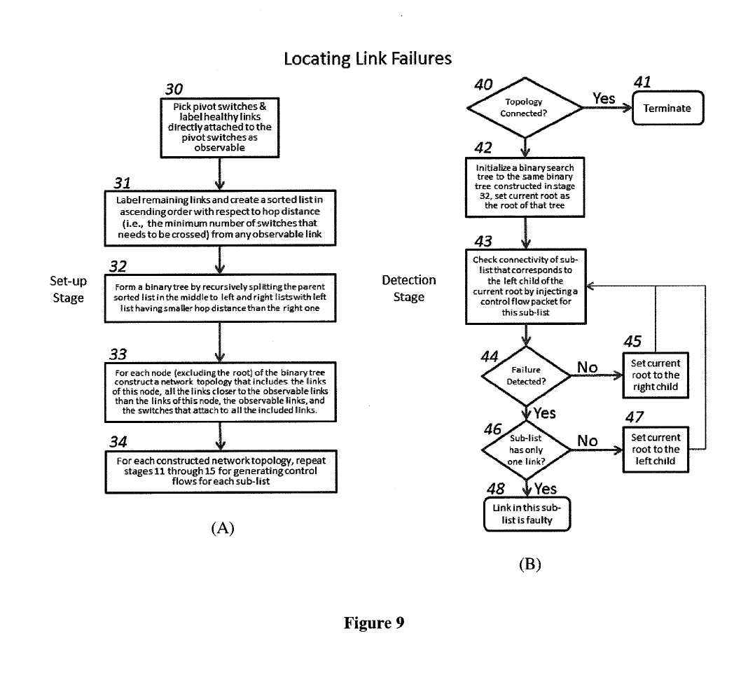

In another embodiment, after detecting that there are link failures, the controller starts using other control flows and their preinstalled forwarding rules on the forwarding elements to locate where these failures occur. FIGS. 9A and B are flow diagrams depicting one embodiment of a process for determining which forwarding rules should be installed on which switches (i.e., the set up stage) as well as locating failure locations (i.e., the detection stage). The process is performed by processing logic that may comprise hardware (circuitry, dedicated logic, etc.), software (such as is run on a general purpose computer system or a dedicated machine), firmware, or a combination of these three.

Referring to FIG. 9A, the process begins by processing logic in a given controller selecting a set of pivot switches and labeling healthy links directly attached to them as observable (processing block 30). The choice of pivot switches is critical as when partition events occur, as the controller uses the links attached to them to inject control flow traffic. Thus, these pivot switches and the controller must be in the same partition after control plane failures, otherwise the forwarding rules that were installed become unusable.

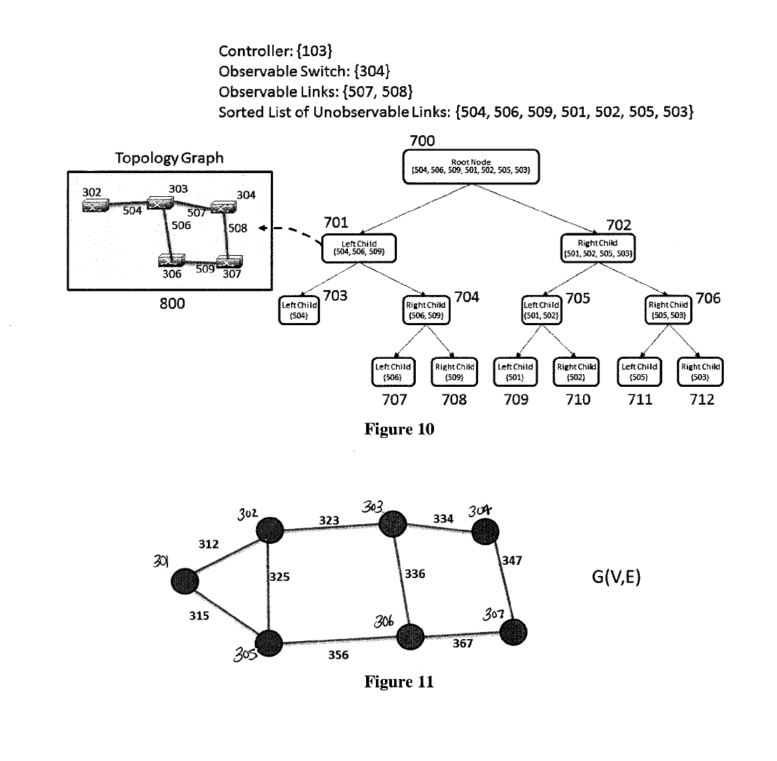

In one embodiment, processing blocks 30-34 are repeated for each forwarding element as the only pivot switch. This potentially leads to a situation in which each switch has multiple forwarding rules, each of which corresponds to distinct choices of pivot switch. In another embodiment, only the ingress and/or egress switches are used as pivot switches as they are the critical points for traffic engineering. In FIG. 10, assuming the network depicted in FIG. 1A, controller 103 uses switch 304 as the pivot switch and thus can inject packets onto links 507 and 508.

Referring back to FIG. 9A, processing logic in the controller puts all the links except for the links labeled as observable in a sorted list in ascending order (processing block 31). In one embodiment, these links are assigned weights where, for a given link, its weight is equal to the shortest distance (e.g., the minimum number of forwarding elements that needs to be crossed) from observable links to this link. In one embodiment, the list sorting is done with respect to these link weights. The links with the same weight can be ordered arbitrarily among themselves. In FIG. 10, this sorted list is computed as {504, 506, 509, 501, 502, 505, 503}.

After creating the sorted list, processing logic in the controller forms a binary tree by recursively splitting the sorted list in the middle to create two sub-lists: a left list and a right list (processing block 32). In one embodiment, the links in the left list have strictly less weights than all the links in the right list. FIG. 10 provides the result of such a recursive splitting where each sub-list is uniquely labeled as 701 through 712.

Thereafter, processing logic in the controller constructs a topology graph for each node in the binary tree constructed in processing block 32 except for the root node (processing block 33). In one embodiment, the topology graph includes all the observable links, all the links included in the sub-list of current node in the binary tree, and all the links closer to the observable links than the links in the sub-list of current node. Furthermore, all the switches that are end points of these links are also included in the topology. In FIG. 10, an example is given for node 701. Node 701 has the sub-list {504, 506, 509}. There are no other links closer to the observable links {507, 508}. Thus, the topology includes the links {504, 506, 507, 508, 509}. Since end points of these links are {302, 303, 304, 306, 307}, these switches are also part of the topology.

Lastly, processing logic repeats processing blocks 11-15 disclosed in FIG. 8A as they are identical. To locate link failures, the current method preinstalls separate traversal rules for each node in the binary tree.

In another embodiment, instead of including each observable link as a distinct link in the topology construction, observable links can be lumped together as a single virtual link. This would result in a more efficient Hamiltonian cycle computation as the last link in the cycle can jump to the closest link in the set of observable links.

If the controller wants to detect the link failure that is closest to the pivot switch(s), then performing processing blocks 40-48 of FIG. 9B results in identifying that link failure. For locating link failure, the process begins by processing logic verifying the connectivity of the topology (processing block 40). In one embodiment, this is performed using the process of FIGS. 8A and B, although other techniques can be used. If the topology connectivity is verified, then the topology is connected and the process ends (processing block 41). Otherwise, processing logic in the controller starts a walk on the binary tree constructed in processing block 32. Processing logic in the controller first injects a control flow packet for the left child of the current root node (processing block 43) and then processing logic tests whether a failure has been detected by determining if the packet has been received back (processing block 44). If the packet is received back, then processing logic determines that there is no failure and transitions to processing block 45. If the packet hasn't been received back, processing logic determines that a failure in one or more links in the sub-list of the child node has occurred and transitions to processing block 46.

If the left child is determined to be healthy, then processing logic continues to search by setting the right child as the new root and repeating processing blocks 43 and 44 using the control flow installed for the left child of this new root. If a failure is detected for any left child node, processing logic in processing block 46 checks whether the list has only one link or more. If the list has only one link, then that link is at fault and process ends (processing block 48). If more than one link is in the sub-list, then processing logic continues to search by setting the current root to the current node and traversing its left child (processing blocks 47 and 43). In one embodiment, the control packet injection is performed in the same fashion as when checking the topology connectivity, but the controller starts with an observable link to inject the control packet.

In one embodiment, if the same switch has to process multiple control packets injected for different child nodes of the binary tree, a unique bit-mask is used to differentiate between these control packets. The choice is up to the controllers themselves and any field including the source port, VLAN tags, MPLS labels, etc. can be used for this purpose. In one embodiment, if a switch does exactly the same forwarding for different control flows, they are aggregated into a single forwarding rule, e.g., by determining a common prefix and setting the remaining bits as don't care in the bit-mask of control flow identifier.

Although processing blocks 40-48 are used to determine the location of the closest link failure, one can use the installed control flows to check each node of the sub-tree and determining which sub-lists include failed links. This way the controller can identify the disconnected portions of the topology. For instance, according to FIG. 10, controller 103 uses 12 control flows set up for nodes 701 through 712 and inject control flow packets onto observable links. In the failure example given in FIG. 3, controller 103 identifies the following by traversing binary tree nodes:

{504, 506, 509} has faulty link(s)

{504} is faulty

{506, 509} has faulty link(s)

{506} is faulty

{509} is not faulty

Thus, the controller can identify with no ambiguity that links 504 and 506 are faulty. However, stating with no ambiguity that these are the only errors is not possible as the topologies constructed in processing block 33 for nodes 702, 705, 706, 709, 710, 711, and 712 include these faulty links.

In small topology instances with fewer alternative paths to reach links in a given node of the binary tree, one can construct a different topology for each alternative path in processing block 33 where only the links of the current tree node, the links of observable links, and links of this alternative path are included in the topology. In such a deployment, for each alternative path, processing logic in the controller computes a separate control flow. For instance, for node 702, in one topology links {501, 502, 503, 505, 507, 508, 509} are included, in a second topology links {501, 502, 503, 504, 505, 507, 508} are included, in a third topology links {501, 502, 503, 505, 506, 507, 508} are included. Traversal of these links would identify that only the first topology is connected whereas the second and third topologies are not connected. Thus, each link failure could be separately identified.

### Additional Embodiments

There are alternative embodiments of techniques for verifying the connectivity of interfaces in a forwarding plane. These can be done for two different scenarios: symmetric failure case and asymmetric failure case.

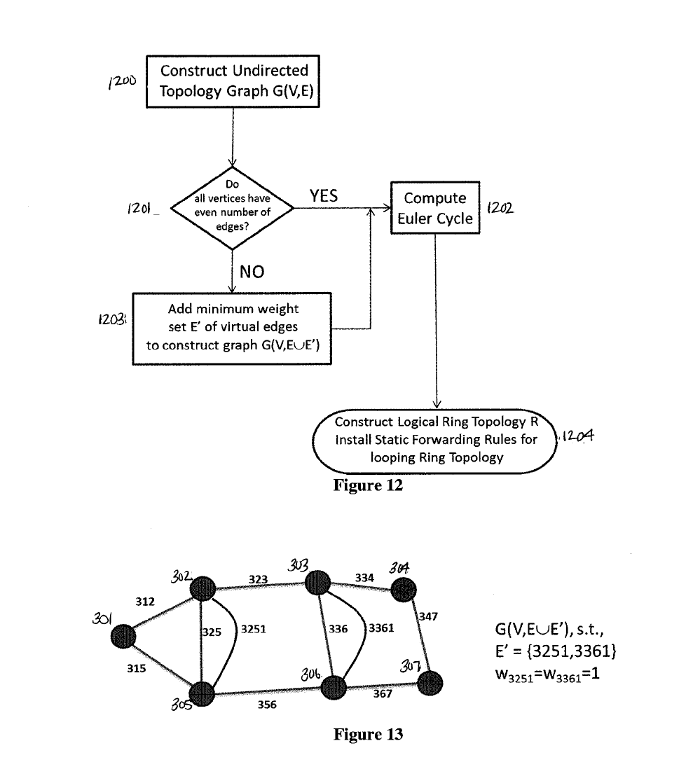

In the symmetric failure cases, if one direction of the interface is down then the other direction is also down. For instance, interface 312 between forwarding elements 301 and 302 in FIG. 1B is bidirectional under normal conditions. Thus, interface 312 can send packets from 302 to 301 and 301 to 302. Since failure of interface 312 from 302 to 301 implies also a failure of interface from 301 to 302 and vice versa, the controller is satisfied if it can check each interface in at least one direction. Under these conditions, in one embodiment, the forwarding plane is represented by an undirected topology graph G(V,E), where V is the set of vertices corresponding to the forwarding elements and E is the set of edges corresponding to the interfaces between the forwarding elements. FIG. 11 shows an example of an undirected graph representation for the forwarding plane shown in FIGS. 1B-1D. Referring to those FIGS. 1B-1D, forwarding elements 301 to 307 constitute the vertices of this graph and the interfaces in between are the undirected edges of unit weight. FIG. 12 is a flow diagram of a process for constructing a virtual ring topology using the graph such as shown in FIG. 11 as the starting point. In one embodiment, the computed ring topology is used to determine static forwarding rules to be installed to create a cycle (a routing loop) that visits each interface in the forwarding plane at least once. Furthermore, the operations set forth in FIG. 12 ensure that the ring size is reduced, and potentially minimized, i.e., it is the shortest possible routing loop that visits every interface at least once.

The process in FIG. 12 is performed by processing logic that may comprise hardware (circuitry, dedicated logic, etc.), software (such as is run on a general purpose computer system or a dedicated machine), firmware, or a combination of these three. Referring to FIG. 12, processing logic constructs an undirected graph G(V,E) from the forwarding plane topology (processing block 1200). In one embodiment, the edges are assumed to have unit weights. A goal of the process is to find a cycle on this graph such that it is the shortest cycle that visits each edge at least once. An Euler cycle in a graph tries to visit all the interfaces on that graph exactly once. Thus, if a Euler cycle exists, it is the shortest possible cycle.

After constructing an undirected graph G(V,E), processing logic determines whether all vertices on the graph has even number of edges (i.e., even degree) (processing block 1201). If the answer is affirmative, then the undirected graph G(V,E) has an Euler cycle, and the process transitions to processing block 1202 wherein processing logic computes the Euler cycle. If the answer is negative, then the undirected graph G(V,E) does not have an Euler cycle. As an intermediate step, processing logic constructs a new graph by adding a minimum cost subset of virtual edges between vertices such that on this graph every vertex has an even degree (processing block 1203). In one embodiment, the cost of subset is the sum of weights of each edge in that subset. The weight of a virtual edge is the minimum number of hops it takes to reach from one end of the virtual edge to the other over the original graph G(V,E). In one embodiment, this weight is computed by running a shortest path algorithm such as, for example, Dijkstra's Algorithm on G(V,E). Finding a minimum cost subset of virtual edges between vertices is well established in the literature. For example, see Edmonds et al., “Matching, Euler Tours and the Chinese Postman” in Mathematical Programming 5 (1973).

Once such a virtual edge set E′ is computed, the graph is augmented to G(V,E∪E′). Processing logic computes the Euler cycle over this new graph (processing block 1202). Computation of Euler cycle is also well known in the art and any such well-known algorithm can be used as part of processing block 1202.

Lastly, processing logic constructs a logical ring topology using the computed Euler cycle (processing block 1204). Using the logical ring topology, a set of static forwarding rules and a control flow that matches to these forwarding rules are determined such that when a controller injects a packet for the control flow into any forwarding element, that packet loops following the logical ring topology.

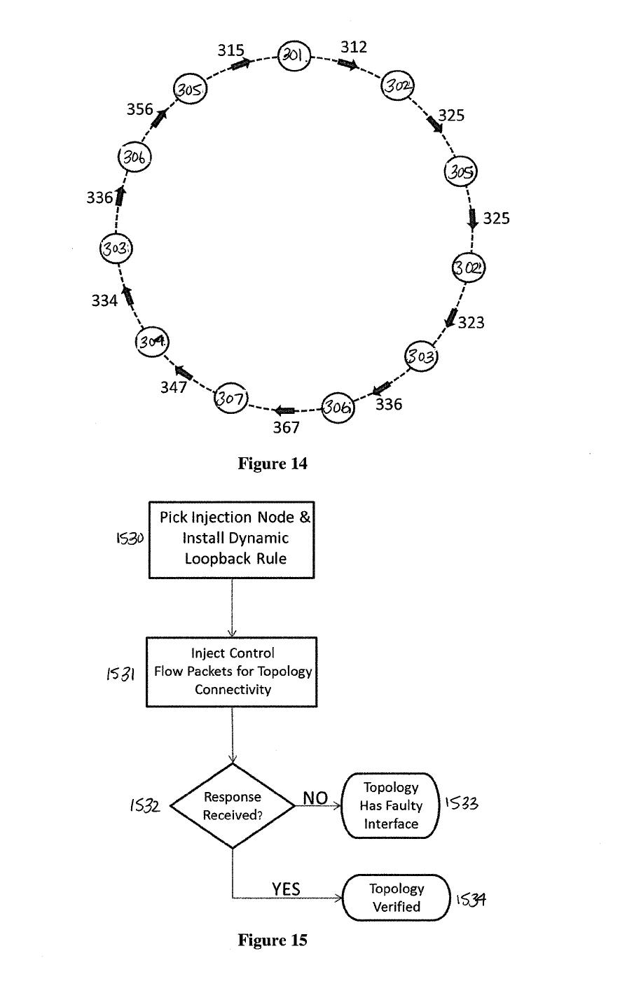

The forwarding topology in FIG. 1B has a graph that includes vertices with odd number of edges. In one embodiment, the forwarding topology is augmented to a graph with all vertices having an even degree. Following processing blocks 1202 and 1203 of FIG. 12, a new minimal graph is constructed as shown in FIG. 13. Referring to FIG. 13, virtual edges 3251 and 3361 are added as a result. Over this new graph, an Euler cycle exists with total cost of 11 hops. One possible Euler cycle and the logical ring topology are shown in FIG. 14. Static forwarding rules are installed such that a matching flow loops the logical ring in one (e.g., clockwise) direction. When the cycle involves a given forwarding interface in the same direction only once, then a simple rule that matches on the incoming interface at the corresponding forwarding element would be sufficient to create a cycle. In FIG. 14, interface 325 occurs twice on the cycle but it is traversed in different directions (i.e., incident on a different forwarding element). Thus, each occurrence can be resolved easily by installing corresponding forwarding rules on the corresponding forwarding element. When a given forwarding interface is traversed in the same direction more than once, each instantiation is differentiated from each other using multiple forwarding rules. In the cycle in FIG. 14, interface 336 occurs twice and in both occurrences it is incident on the same forwarding element (306). Thus, the forwarding element has two distinct forwarding rules where each occurrence matches to one, but not to the other. One way of achieving this is to reserve part of a header field to differentiate between occurrences. For instance, in one embodiment, the VLAN ID field is used for this purpose if the forwarding elements support this header. Naturally, if forwarding rules are set with respect to VLAN ID and/or incoming interface, many flows would be falsely matched to these rules and start looping. In one embodiment, only a pre-specified control flow is allowed to be routed as such. One way of setting a control flow is to use a reserved source or destination transport port (e.g., UDP or TCP) or use source or destination IP address prefix common to all controllers. The flows that do not match to these header values unique to the controllers do not have a match and would not be routed according to the static rules installed for the control flow.

Following the above guidelines, one can easily compute the static forwarding rules for the logical ring topology in FIG. 14. These rules are set such that the ring is traversed in clockwise direction.

TABLE 2
STATIC FORWARDING RULES for RING TOPOLOGY in FIG. 13

| Switch Name | Matching Rule | Action |
|---|---|---|
| 301 | {destination UDP, incoming interface} = | Send to link 312 |
| | { udp1, 315} | |
| 302 | {destination UDP, incoming interface} = | Send to link 325 |
| | {udp1, 312} | |
| 302 | {destination UDP, incoming interface} = | Set VLAN id = |
| | {udp1, 325 } | v202 |
| | | Send to link 323 |
| 303 | {destination UDP, incoming interface} = | Send to link 336 |
| | {udp1, 323 } | |
| 303 | {destination UDP, incoming interface} = | Send to link 336 |
| | {udp1, 334 } | |
| 304 | {destination UDP, incoming interface} = | Set VLAN id = |
| | {udp1, 347 } | v204 |
| | | Send to link 334 |
| 305 | {destination UDP, incoming interface} = | Send to link 325 |
| | {udp1, 325 } | |
| 305 | {destination UDP, incoming interface} = | Send to link 315 |
| | {udp1, 356 } | |
| 306 | {destination UDP, VLAN id, incoming | Send to link 367 |
| | interface} = { udp1, v302, 336} | |
| 306 | {destination UDP, VLAN id, incoming | Send to link 356 |
| | interface} = { udp1, v304, 336} | |
| 307 | {destination UDP, incoming interface} = | Send to link 347 |
| | {udp1, 367} | |

Once these static rules for the control flow identified with a UDP port number in the example above, any controller can piggyback on this control flow for topology verification. FIG. 15 is a flow diagram of one embodiment of a process for topology verification. The process in FIG. 15 is performed by processing logic that may comprise hardware (circuitry, dedicated logic, etc.), software (such as is run on a general purpose computer system or a dedicated machine), firmware, or a combination of these three.

Referring to FIG. 15, the process begins with processing logic of a controller determining its current control domain and selecting an arbitrary node in its control domain as an injection and loopback point (processing block 1530). This arbitrary node is to receive the control message for topology verification from its controller via the control interface, place the control message onto the forwarding plane, and loopback the message back to the controller when the message comes back to itself looping through the logical ring topology. To achieve this last loopback functionality, the controller installs a new (dynamic) rule before injecting the topology verification message. Otherwise, the message will be indefinitely looping through the logical ring topology. In one embodiment, the dynamic rule is installed by updating the static rule that points to the next hop in the logical topology ring such that it now points to the controller. Although this is possible, it is not preferred as it can interfere with other controllers' messages. In another embodiment, a new forwarding rule in inserted by specifying controller specific header field match (e.g., IP or MAC address of the controller injecting the control message) in addition to the fields used in the static rule. Thus, at this forwarding element used as injection and loopback point, two rules (one static and one dynamic) matches to a control message injected by the same controller. But a control message sent by a different controller would match only to the static rule and not to the dynamic rule installed by another controller. In one embodiment, of forwarding elements, by default the longest match has the higher priority. In another embodiment, the last installed rule has higher priority. Yet in another embodiment, the controller can explicitly set the priority of different matching rules.

Then processing logic injects a packet into the forwarding plane using the injection point (processing block 1531). In one embodiment, the controller explicitly specifies the outgoing interface/port for the control packet is generates. In this case, the forwarding element is receiving a control message that specifies the outgoing interface as one part of the message and the packet that is to traverse the forwarding plane as another part of the same message. The forwarding element does not apply any forwarding table look up for such a control message.

In another embodiment, the controller send a control message specifying the packet that is to traverse the forwarding plane as part of the message, but instead of specifying the outgoing port, the controller specifies the incoming port in the forwarding plane as another part of the message. In such a case, the packet to be forwarded into the control plane is treated as if it is received from the specified incoming port and thus goes through forwarding table look ups and processing pipelines as a regular payload. The usage assumed in presenting the static rules in Table 2 is the former one, i.e., controller specifies the outgoing port and bypass the forwarding table. If the latter one is used, then differentiating multiple traversals of the same interface in the same direction is necessary between the first injection and last loopback. In one embodiment, this is done using VLAN id field or any other uniquely addressable field in the packet header or by specifying push/pop actions for new packet header fields (e.g., MPLS labels). The example static rules presented in Table 2 then are revised accordingly.

Next, processing logic the controller waits to receive the payload it injected into the forwarding plane (processing block 1532). If processing logic receives the message is back (processing block 1533), then the topology connectivity is verified and no fault is detected. If a response is missing (processing block 1534), then the topology is not verified and a potential fault exists in the forwarding plane. In one embodiment, the controller re-injects a control packet to (re)verify the topology connectivity in either conclusion. Note that a control flow can be sent as a stream or in bursts to find bottleneck bandwidth and delay spread as well.

As an example, consider the case in FIG. 1D where controller 101 has D101={301, 302, 305}. Thus, controller 101 can select any forwarding element in D101 as the injection and loopback point. Suppose controller 101 selects forwarding element 302 in this role. Then, it can first install a new (dynamic) rule (also referred to as loopback rule) to accompany the static rules in Table 2 in the form:

If {destination UDP, incoming interface, source IP}={udp1, 312, IP101} then send to controller 101 via control interface.

Controller 101 can then marshal a control message part of which that specifies the outgoing interface (say 325) and part of which is an IP payload with source and destination UDP ports specified as udp1 and source IP address is filled by IP101. Controller 101 sends this message to forwarding element 302 which unpacks the control message, sees that it is supposed to forward the IP payload onto the outgoing interface specified in the control message. Then, forwarding element 302 forwards the IP payload to the specified interface (i.e., 325). As the IP payload hits the next forwarding element, it starts matching the forwarding rules specified in Table 1 and takes the route 305 302 303 306 307 304 303 306-305-301-302 to complete a single loop. When forwarding element 302 receives the IP payload from incoming interface 312 with source IP field set as IP101 and source UDP port set as udp1, this payload matches to the loopback rule set by controller 101. Thus, forwarding element 302 sends (i.e., loopbacks) the IP packet to controller 101 using the control interface 412.

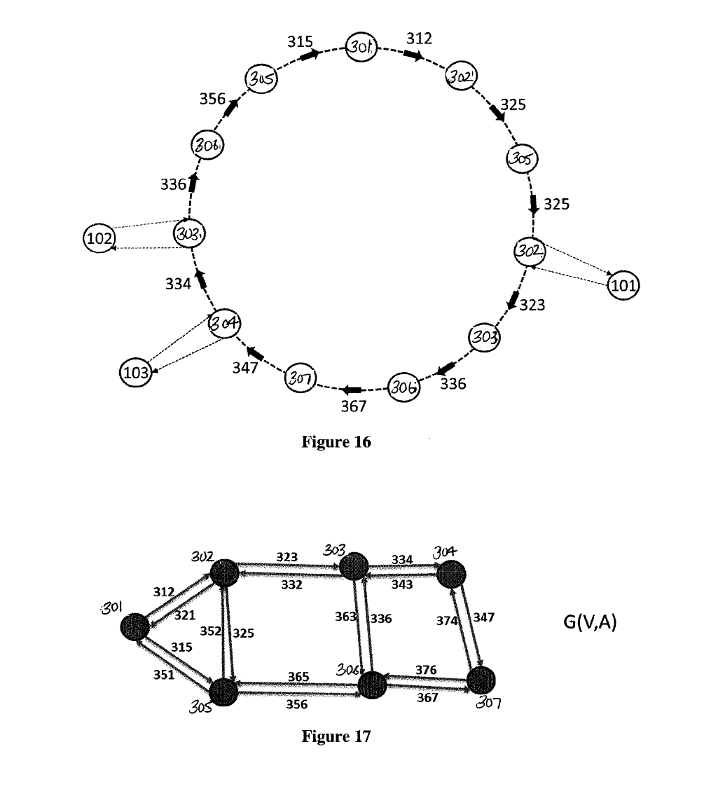

Multiple controllers share the same set of static forwarding rules to verify the topology, but each must install its own unique loopback rule on the logical ring topology. By doing so, multiple controllers can concurrently inject control packets without interfering with each other. Each control packet makes a single loop (i.e., comes back to the injection point) before passed on to the controller. FIG. 16 shows the case where controllers 101, 102, and 103 inject control packets onto the logical ring topology using a forwarding element in their corresponding control domains (according to the example in FIG. 1B). According to the logical ring and choice of injection points in FIG. 16, Table 3 summarizes the dynamic rules that can be installed as loopback rules.

TABLE 3
Example of Dynamic Loopback Rules Installed by Multiple Controllers

| Controller | Switch | Matching Rule | Action |
|---|---|---|---|
| 101 | 302 | {destination UDP, incoming interface, | Send to |
| | | source IP} = {udp1, 325, IP101} | Controller |
| | | | 101 |
| 102 | 303 | {destination UDP, incoming interface, | Send to |
| | | source IP} = {udp1, 334, IP102} | Controller |
| | | | 102 |
| 103 | 304 | {destination UDP, incoming interface, | Send to |
| | | source IP} = {udp1, 347, IP103} | Controller |
| | | | 103 |

The above alternative embodiments involve the symmetric case where a given controller is satisfied if only one direction of each interface is verified. Extension to the asymmetric case, where a failure in one direction of an interface does not imply the failure in the other direction, the controller would like to verify each direction separately. In one embodiment, this is done by treating the forwarding plane as a directed graph G(V, A), where V is the set of vertices corresponding to the set of forwarding elements as before and A is the set of arcs (i.e., directed edges) corresponding to the set of all interfaces by counting each direction of an interface as a separate unidirectional interface. FIG. 17 is an example of such a graph for the forwarding plane shown in FIG. 1B.

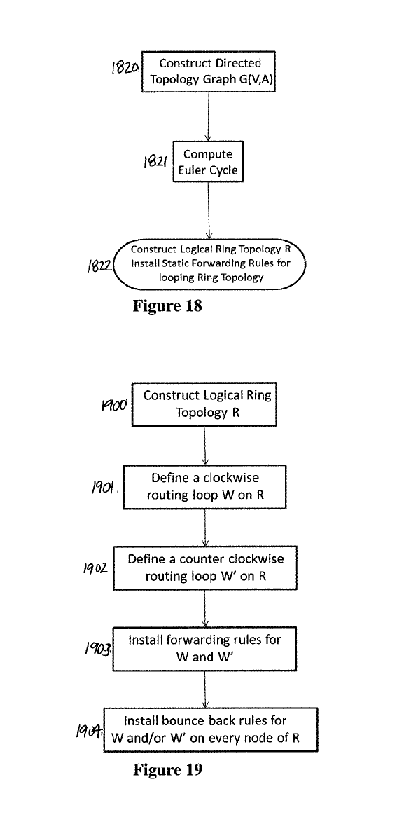

The main difference of having a directed graph is that since we assume each interface is bidirectional, the resulting directed graph is symmetric and it is guaranteed to have an Euler cycle which can be computed efficiently and we do not need to further augment the graph. Thus, the operations listed in FIG. 12 simplifies to FIG. 18. The process in FIG. 18 is performed by processing logic that may comprise hardware (circuitry, dedicated logic, etc.), software (such as is run on a general purpose computer system or a dedicated machine), firmware, or a combination of these three.

Referring to FIG. 18, the process begins by mapping the global forwarding plane topology into a directed graph (processing block 1820) and proceeds with directly computing the Euler cycle (processing block 1821). The process ends up processing logic constructing a logical ring topology R following this particular Euler cycle and computing the static forwarding rules (processing block 1822). As before, the total number of static forwarding rules equal to the length of the Euler cycle, and in this case it is exactly |A|=2|E|, were |x| is the cardinality (size) of set x. The manner in which the forwarding rules static and dynamic (e.g., loopback rules) are computed and installed as well as how the controller verifies the overall topology are the same as in the symmetric failure case. In one embodiment, the only difference is the constructed logical ring topology, which requires different set of rules.

Embodiments of the invention not only verify whether a topology is connected as it is supposed to be, but also discloses efficient methods of locating at least one link failure. FIG. 19 is a flow diagram of a process for computing a set of static forwarding rules used to locate an arbitrary link failure. The process is performed by processing logic that may comprise hardware (circuitry, dedicated logic, etc.), software (such as is run on a general purpose computer system or a dedicated machine), firmware, or a combination of these three.

Referring to FIG. 19, the process begins with processing logic constructing a ring topology R that traverses each interface at least once (processing block 1900). The process of finding the ring topology R is already described for symmetric and asymmetric link failure cases in FIG. 12 and FIG. 18, respectively. Next, processing logic defines a clockwise walk W (processing block 1901) and defines a counter clockwise walk W′ by reversing the walk W (processing block 1902). Processing logic realizes these walks as routing loops by installing static forwarding rules (processing block 1903). Lastly, processing block 1904 depends on the particular embodiment. In one embodiment, processing logic installs one bounce back rule per hop to reverse the walk W′ at an arbitrary point on the logical ring and continue the walk on W. In another embodiment, processing logic installs one bounce back rule per hop to reverse the walk W at an arbitrary point on the logical ring and continue the walk on W′. In yet another embodiment, processing logic installs two bounce back rules at each node on the logical ring: one to reverse the walk W′ onto W and the other to reverse the walk W onto W′.

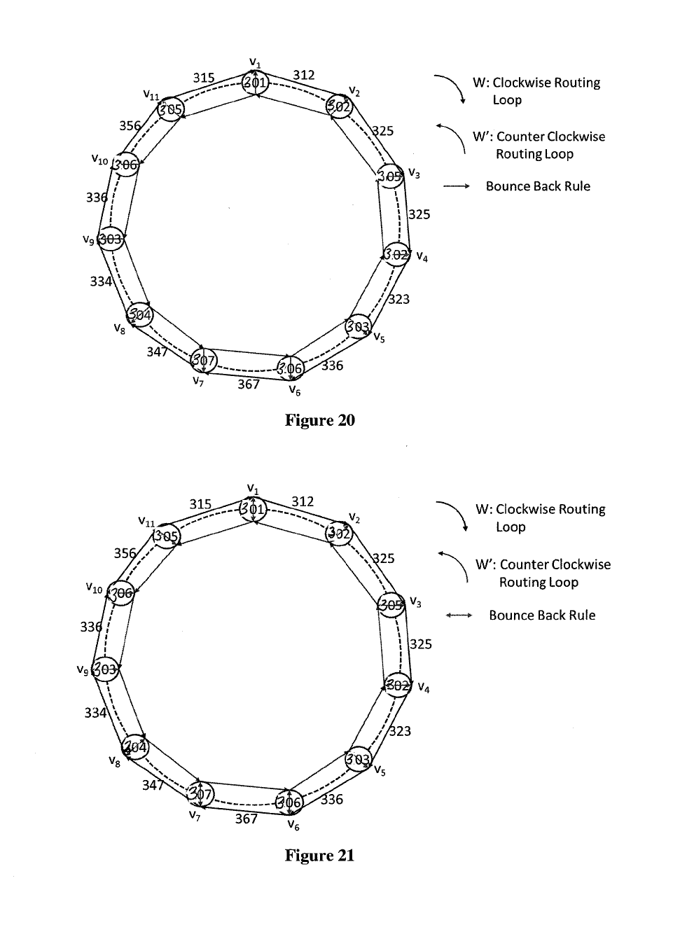

FIG. 20 shows an example for the topology given in FIG. 1B-1D assuming the undirected graph in FIG. 11. In this example, counter clockwise walk W′ and clockwise walk W are installed. In one embodiment, the static rules presented in Table 2 are installed on the corresponding forwarding elements to realize clockwise routing loop W. In one embodiment, the static rules in Table 2 are modified by substituting the incoming interface values with the outgoing interface values at each row to realize the counter clockwise walk W′. If the same interface is crossed multiple times in the same direction, then these different occurrences are counted with proper packet tagging. The nodes that perform the tagging and the nodes that use the tag information for routing change between W and W′. For instance, in W, interface 336 is crossed going from forwarding element 303 to forwarding element 306 twice. The forwarding element preceding this crossing performs the tagging (i.e., forwarding elements 304 and 302 for W) and the egress forwarding element 306 uses this tagging to take the correct direction (305 or 307). On reverse walk W′, 336 is crossed twice but in the reverse direction (from 306 to 303). Thus, the forwarding elements preceding 306 on W′ this time performs the tagging (forwarding elements 305 and 307) and the egress forwarding element 303 uses this tagging to take the correct direction (302 or 304). Moreover, to distinguish the clockwise walk from the counter clockwise walk, one needs to set a unique value in the packet header, e.g., a unique destination transport port number. This differentiation is only required when the same interface is crossed in opposite directions as part of walk W. For the example topology ring in FIG. 20, the interface 325 is crossed in both directions. Thus, forwarding element 305 must know which walk the packet is taking by checking the unique header field. These rules are shown in Table 4.

According to processing block 1904 in FIG. 19, a distinct bounce back rule is installed on each vertex to be able to switch from W′ to W at any vertex. Each bounce back rule is specific to a unique control packet id. For this purpose any reserved range for the supported header fields can be used. For instance we can assign each vertex k on R a unique virtual IP address vipk (virtual in the sense that it does not belong to a physical interface, but simply used to enumerated vertices of the logical ring). A forwarding element can be mapped to multiple vertices and they are counted separately. For instance in FIG. 20, forwarding elements 302, 303, 305, 306 map to two distinct vertices on R and for each vertex, they are assigned a distinct IP address, e.g., forwarding element 302 maps to v2 and v4, thus bounce back rules set for vip2 and vip4 are installed on forwarding element 302. The bounce back rules for FIG. 20 are reported in Table 4.

TABLE 4
STATIC FORWARDING RULES for W′ in FIGS. 20 & 21

| Switch Name | Matching Rule | Action |
|---|---|---|
| 301 | {destination UDP, incoming interface} = | Send to link 315 |
| | {udp2, 312} | |
| 302 | {destination UDP, incoming interface} = | Send to link 312 |
| | {udp2, 325} | |
| 302 | {destination UDP, incoming interface} = | Send to link 325 |
| | {udp2, 323} | |
| 303 | {destination UDP, VLAN id, incoming | Send to link 323 |
| | interface} = {udp2, v307, 336} | |
| 303 | {destination UDP, incoming interface} | Send to link 334 |
| | {udp2, v305, 336} | |
| 304 | {destination UDP, incoming interface} | Send to link 347 |
| | {udp2, 334} | |
| 305 | {destination UDP, incoming interface} | Send to link 325 |
| | {udp2, 325} | |
| 305 | {destination UDP, incoming interface} = | Set VLAN id = |
| | {udp2, 315} | v305 |
| | | Send to link 356 |
| 306 | {destination UDP, incoming interface} = | Send to link 336 |
| | {udp2, 367} | |
| 306 | {destination UDP, incoming interface} = | Send to link 336 |
| | {udp2, 356} | |
| 307 | {destination UDP, incoming interface} = | Set VLAN id = |
| | {udp2, 347} | v307 |
| | | Send to link 367 |

TABLE 5
Bounce back rules to switch from W′ to W for Ring Topology in
FIGS. 20 & 21

| Switch | | |
|---|---|---|
| Name | Matching Rule | Action |
| 301 | {destination UDP, destination IP, | Set destination UDP = udp1 |
| | incoming interface} = {udp2, vip1, | Send to link 312 |
| | 312} | |
| 302 | {destination UDP, destination IP, | Set destination UDP = udp1 |
| | incoming interface} = {udp2, vip2, | Send to link 325 |
| | 325} | |
| 302 | {destination UDP, destination IP, | Set destination UDP = udp1 |
| | incoming interface} = {udp2, vip4, | Set VLAN id = v302 |
| | 323} | Send to link 323 |
| 303 | {destination UDP, destination IP, | Set destination UDP = udp1 |
| | incoming interface} = {udp2, vip5, | Set VLAN id = v302 |
| | 336} | Send to link 336 |
| 303 | {destination UDP, destination IP, | Set destination UDP = udp1 |
| | incoming interface} = {udp2, vip9, | Set VLAN id = v304 |
| | 336} | Send to link 336 |
| 304 | {destination UDP, destination IP, | Set destination UDP = udp1 |
| | incoming interface} = {udp2, vip8, | Set VLAN id = v304 |
| | 334} | Send to link 334 |
| 305 | {destination UDP, destination IP, | Set destination UDP = udp1 |
| | incoming interface} = {udp2, vip3, | Send to link 325 |
| | 325} | |
| 305 | {destination UDP, destination IP, | Set destination UDP = udp1 |
| | incoming interface} = {udp2, | Send to link 315 |
| | vip11, 315} | |
| 306 | {destination UDP, destination IP, | Set destination UDP = udp1 |
| | incoming interface} = {udp2, vip6, | Send to link 367 |
| | 367} | |
| 306 | {destination UDP, destination IP, | Set destination UDP = udp1 |
| | incoming interface} = {udp2, | Send to link 356 |
| | vip10, 356} | |
| 307 | {destination UDP, destination IP, | Set destination UDP = udp1 |
| | incoming interface} = {udp2, vip7, | Send to link 347 |
| | 347} | |

FIG. 21 depicts the case where bounce back rules are used for both clockwise and counter clockwise walks. By substituting udp1 with udp2 and udp2 with udp1 in Table 5, as well as setting the right VLAN ID field, the static bounce back rules to switch from walk W to W′ at each node of the topology ring are obtained. Having two bounce back rules as such would enable any controller to inspect the topology ring in both directions enabling detection of more failures and shorter routes.

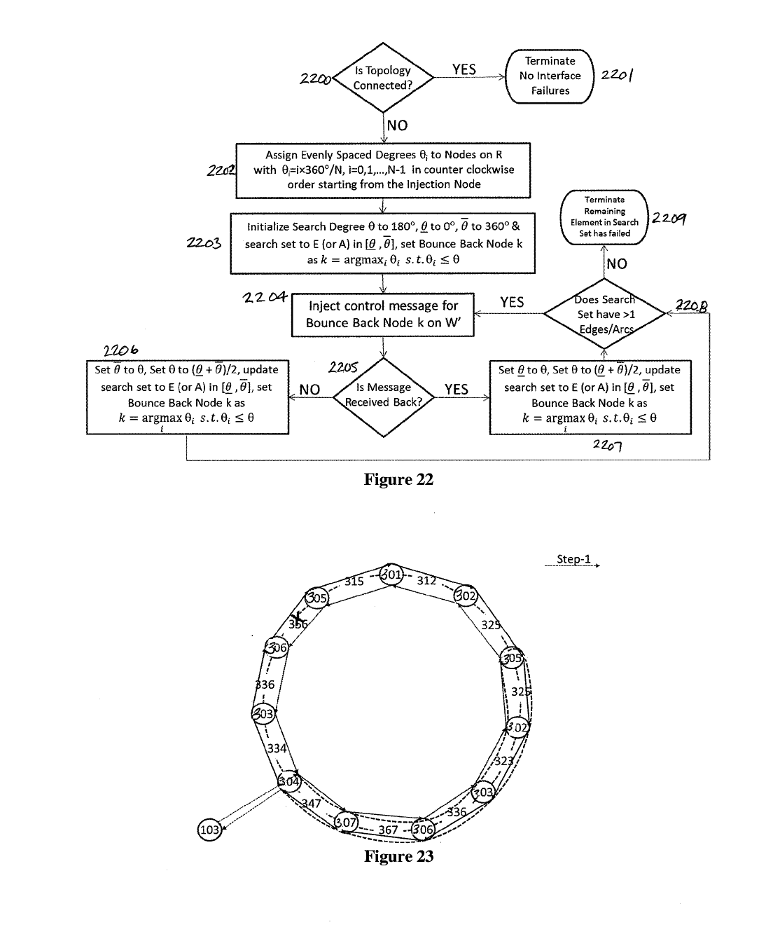

To actually locate an arbitrary link failure, controllers inject packets into the forwarding plane that are routed according to the installed static rules which follow the logical ring topology R. The controller selects a forwarding element in its control domain as an injection and loopback point. As in the case of topology verification, a loopback forwarding rule is installed on the injection point before any packet is injected. Loopback rules in Table 3 can be used for instance by different controllers over the ring topology depicted in FIG. 20. In one embodiment, controllers use a set up where only one bounce back rule is installed corresponding to the logical ring topology. FIG. 22 is a flow diagram of one embodiment of a process for detecting an arbitrary link failure assuming such bounce back rules are installed to switch from counter clockwise walk W′ to clockwise walk W. The process is performed by processing logic that may comprise hardware (circuitry, dedicated logic, etc.), software (such as is run on a general purpose computer system or a dedicated machine), firmware, or a combination of these three.

Referring to FIG. 22, processing logic in the controller sends one or more topology verification messages to its injection point (processing block 2200). If messages are received back, then all the interfaces are healthy and the procedure terminates (processing block 2201). Note that the procedure can always be repeated based on periodic or aperiodic triggers starting from the beginning a processing block 2200. If none of the topology verification messages are received back, then there is potentially a failed interface and the procedure starts executing the failure detection phase (starts at processing block 2202).

Processing logic in the controller assigns angular degrees to the nodes on the logical ring by assigning 0° to the injection point and evenly dividing 360° between the nodes (processing block 2202). If there are N vertices on the logical ring, each vertex is assumed to be separated evenly by 360°/N (or near evenly if 360°/N is not an integer by rounding the division to the closest integer) and i-th vertex in the counter clockwise direction from the injection point is assigned a degree of i×360°/N. In the example ring of FIG. 20, there are 11 nodes (i.e., vertices) on the logical ring, thus each vertex is assumed to be separated by 360°/11≈33°.

Next, processing logic in the controller initializes the search degree θ to half of the ring, i.e., θ=180° (processing block 2202). In the symmetric failure case, the candidate set of interface failures (i.e., search set) include all the edges in E of the corresponding undirected graph G(V,E). In the asymmetric case, the candidate set of interface failures include all the arcs in A of the corresponding directed graph G(V,A). Since the search set includes initially all the edges on the logical ring topology, the minimum search angle over the ring (i.e., θ) is initialized to 0° and the maximum search angle over the ring (i.e., θ̅) is initialized to 360°. Controller picks a bounce back node by finding the vertex k on the logical ring such that its angle is the maximum one without exceeding the search angle.

Processing logic in the controller injects a control message onto W′ by identifying vertex k as the bounce back node in the payload of that control message (processing block 2204). If the message is not received, then an interface lying between θ̅ and θ on the logical ring R has failed (processing block 2205). Thus, the search is narrowed down to the closed interval [θ, (θ+θ)/2] (processing block 2206) and search set is updated to the interfaces lying on [θ,θ]. If on the other hand the message is received, then the interfaces in the closed interval [0, θ] are visited successfully and can be removed from the search set. In one embodiment, the search angle is expanded by adding half of the unsearched territory on the logical ring topology (processing block 2207). Next, processing logic checks whether the search set has only one interface candidate left or not (processing block 2208). If so, this remaining interface is declared to be at fault (processing block 2209). Otherwise the search continues over the next segment of the logical ring R by injecting a control packet targeting the new bounce back node. The overall search takes approximately log 2(N) search steps (i.e., this many control messages are injected sequentially) if the logical ring has N vertices.

FIGS. 23, 24, and 25 show the three iterations of the binary search mechanism outlined in FIG. 22 over the ring topology example used so far. In step-1 (FIG. 23), half of the ring is searched starting from the injection point in counter clockwise direction and conclude that there are no failures in this segment. In step-2, the search is expanded to roughly the ¾-th of the logical ring and again the conclusion is that the failure is not in this part. In the final step of this example, the lack of response to the control packet implies that the interface 356 should be at fault.

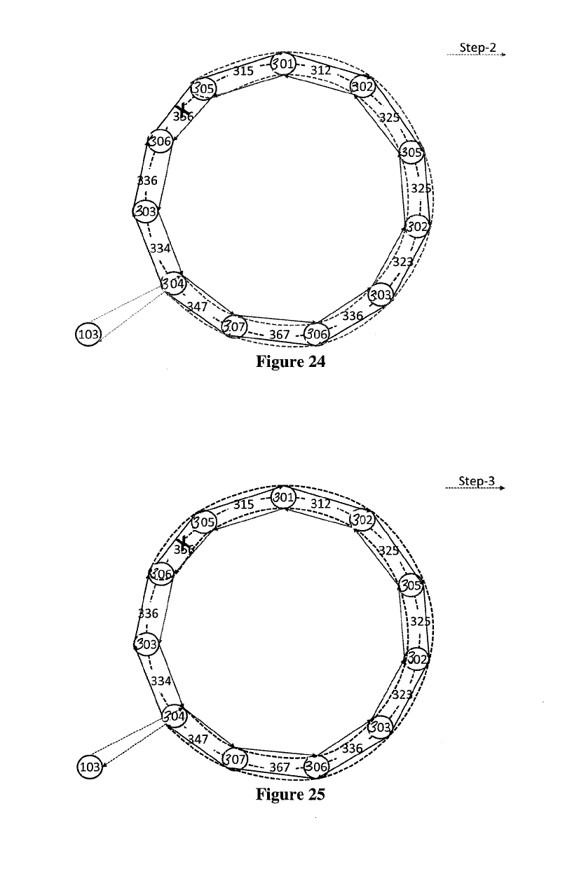

Searching only in one direction of the ring limits the link failure detection to a single link (even when multiple failures could have occurred). Furthermore, when the search is expanded beyond the half of the ring, the control packets unnecessarily traverse half the ring that is known to be healthy (e.g., operations 2 and 3 in FIGS. 24 and 25). If the logical ring has N nodes, then by installing additional N static rules would generate routing rules such that we can traverse both directions of the ring at will and switch from W to W′ or vice versa as highlighted in describing FIG. 21. This enables making shorter walks around the ring and locating up to two link failures.

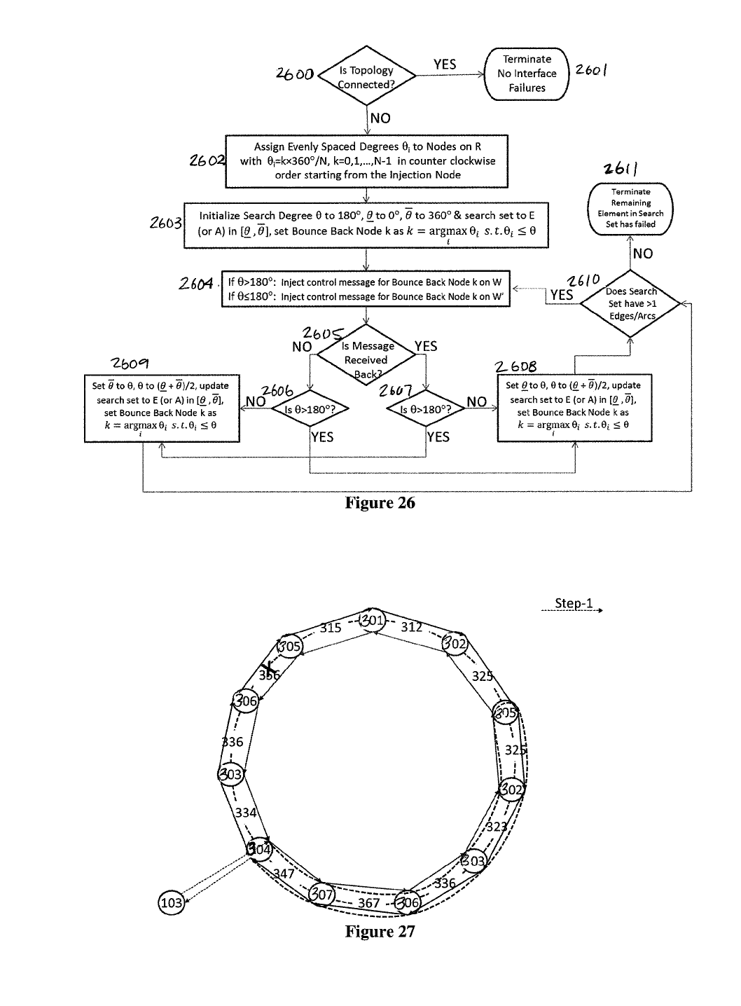

FIG. 26 is a flow diagram of one embodiment of a process for performing a updated binary search. The process is performed by processing logic that may comprise hardware (circuitry, dedicated logic, etc.), software (such as is run on a general purpose computer system or a dedicated machine), firmware, or a combination of these three.

Referring to FIG. 26, the process starts with processing logic verifying the topology connectivity (processing block 2600). If the topology is connected, processing logic declares that no failures exist (processing block 2601). Otherwise; processing logic assigns each vertex on the ring an angle by evenly placing them on the logical ring topology in the counter clockwise direction (processing block 2602). Without loss of generality, processing logic initializes the search to the half of the ring in counter clockwise direction first (processing block 2603). Then processing block 2604 differs from the procedure outlined in FIG. 22 as processing logic checks the search angle. If it is larger than 180°, then processing logic makes the walk in clockwise direction using W. If it is smaller than or equal to 180°, processing logic continues with the counter clockwise walk W′ and the rest of the iterations would be equivalent to the remaining iterations of FIG. 22. The reception or lack of reception of the control message (processing block 2605) implies different things depending on the search degree. If the message is received (processing block 2605) and the search degree was above 180° (processing block 2606), the maximum search degree 0 is reduced (processing block 2609). If the message is received (processing block 2605) and the search degree was less than or equal to 180° (processing block 2606), the minimum search degree θ is increased instead (2608). In contrast, if the message is not received back (processing block 2605) and the search degree was above 180° (processing block 2606), the minimum search degree θ is increased (processing block 2608). And, if the message is not received back (2605) and the search degree was smaller than or equal to 180° (processing block 2606), the maximum search degree θ̅ is reduced (processing block 2609). If the search set has only one interface left (processing block 2610), then processing logic declares that the remaining interface is at fault (processing block 2611). If there is more than one interface in the search set, the iterations continue (processing block 2604). This entire procedure again takes approximately log 2(N) control messages to locate an arbitrary link failure.

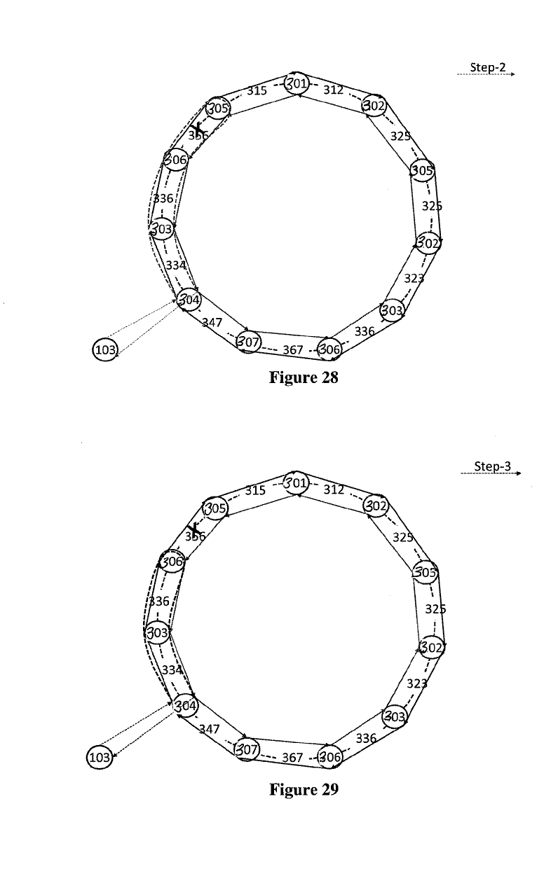

The manner in which the search in FIG. 26 occurs is exemplified over the same failure scenario as before in FIGS. 27, 28, and 29. The first step again searches half of the ring in counter clockwise direction (FIG. 27). Since this half of the ring is found free of fault, the fault must be in the clockwise half starting from the injection node. Thus, in the second step, the search is done in clockwise direction. Different than the step-2 in FIG. 24, this time a fault is detected in the second step in FIG. 25. Rather than reducing the maximum search degree, it is increases and a different bounce back node is selected (v10 according to our earlier labeling in FIG. 21) in the third step. The failed link is identified successfully in this step.

In another embodiment, rather than performing a sequential binary search over the logical ring, we can send control packets in parallel in one or both directions. At the expense of using more control messages, the detection delay can be increased and more link failures can be located. Specifically, the two link failures closest to the injection point can be identified, one in the clockwise direction and the other in the counter clockwise direction. If the controller can reach to more than one injection point, then potentially more link failures can be identified.

In one embodiment, walking in both directions of the ring as well as using more than one injection point require multiple dynamic loopback rules to be installed. As an example, suppose interfaces 334, 336, 347 have failed. Controller 101 can use forwarding elements 301, 302, 305 along with the logical ring constructed as in FIG. 21 to locate failures 336 and 347 while verifying that 367 is still healthy. Thus, even when other controllers cannot be contacted, Controller 101 can extract useful information by bypassing detected failures and using the verified portion of the topology.

### An Example of a System

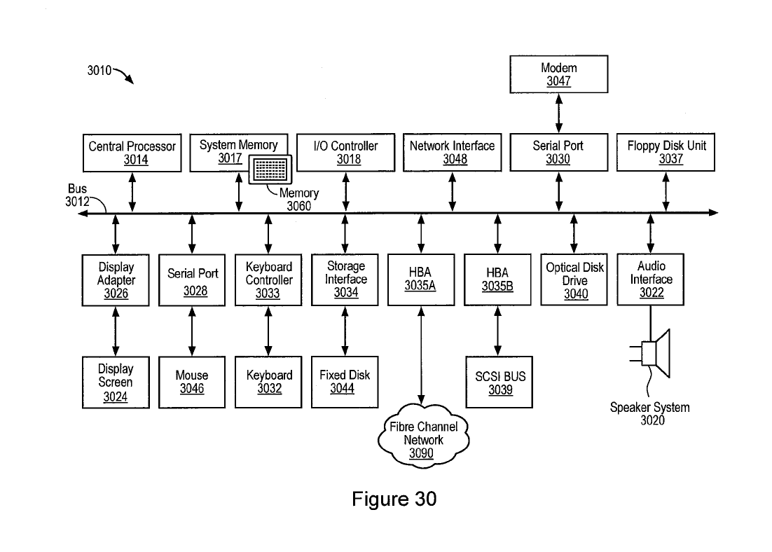

FIG. 30 depicts a block diagram of a system that may be used to execute one or more of the processes described above. Referring to FIG. 30, system 310 includes a bus 3012 to interconnect subsystems of system 3010, such as a processor 3014, a system memory 3017 (e.g., RAM, ROM, etc.), an input/output controller 3018, an external device, such as a display screen 3024 via display adapter 3026, serial ports 3028 and 3030, a keyboard 3032 (interfaced with a keyboard controller 3033), a storage interface 3034, a floppy disk drive 3037 operative to receive a floppy disk 3038, a host bus adapter (HBA) interface card 3035A operative to connect with a Fibre Channel network 3090, a host bus adapter (HBA) interface card 3035B operative to connect to a SCSI bus 3039, and an optical disk drive 3040. Also included are a mouse 3046 (or other point-and-click device, coupled to bus 3012 via serial port 3028), a modem 3047 (coupled to bus 3012 via serial port 3030), and a network interface 3048 (coupled directly to bus 3012).

Bus 3012 allows data communication between central processor 3014 and system memory 3017. System memory 3017 (e.g., RAM) may be generally the main memory into which the operating system and application programs are loaded. The ROM or flash memory can contain, among other code, the Basic Input-Output system (BIOS) which controls basic hardware operation such as the interaction with peripheral components. Applications resident with computer system 3010 are generally stored on and accessed via a computer readable medium, such as a hard disk drive (e.g., fixed disk 3044), an optical drive (e.g., optical drive 3040), a floppy disk unit 3037, or other storage medium.

Storage interface 3034, as with the other storage interfaces of computer system 3010, can connect to a standard computer readable medium for storage and/or retrieval of information, such as a fixed disk drive 3044. Fixed disk drive 3044 may be a part of computer system 3010 or may be separate and accessed through other interface systems.

Modem 3047 may provide a direct connection to a remote server via a telephone link or to the Internet via an internet service provider (ISP). Network interface 3048 may provide a direct connection to a remote server. Network interface 3048 may provide a direct connection to a remote server via a direct network link to the Internet via a POP (point of presence). Network interface 3048 may provide such connection using wireless techniques, including digital cellular telephone connection, a packet connection, digital satellite data connection or the like.

Many other devices or subsystems (not shown) may be connected in a similar manner (e.g., document scanners, digital cameras and so on). Conversely, all of the devices shown in FIG. 30 need not be present to practice the techniques described herein. The devices and subsystems can be interconnected in different ways from that shown in FIG. 30. The operation of a computer system such as that shown in FIG. 30 is readily known in the art and is not discussed in detail in this application.

Code to implement the processes described herein can be stored in computer-readable storage media such as one or more of system memory 3017, fixed disk 3044, optical disk 3042, or floppy disk 3038.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method for use with a pre-determined subset of network flows for a communication network, wherein the network comprises a control plane, a forwarding plane, and one or more controllers, the method comprising:
installing forwarding rules on the forwarding elements for identification of network information, wherein the forwarding rules are grouped into one or more separate control flows, where each of the one or more control flows makes a closed loop walk through at least a portion of the network according to the forwarding rules of said each control flow;
injecting traffic for one or more control flows onto the forwarding plane; and
identifying the network information based on results of injecting the traffic.

2. The method defined in claim 1 wherein the network information comprises one or more of a group consisting of: link failures, topology connectivity, and routability of a pre-determined subset of network flows.

3. The method defined in claim 1 wherein the forwarding rules are for verifying connectivity of an arbitrary network topology graph.

4. The method defined in claim 3 wherein the forwarding rules verify connectivity of the arbitrary network topology graph by constructing a control flow that traverses each link in a forwarding plane in a network topology represented by the topology graph.

5. The method defined in claim 3 further comprising:
computing an Euler cycle if it exists on the topology graph of the forwarding plane;
computing a minimum length cycle;
installing static rules to route one or more control packets according to the computed minimum length cycle; and
installing dynamic loopback rules at an arbitrary point on the routing loop to send the control flow packets injected by the controller back to the controller after each packet completes one full cycle.

6. The method defined in claim 5 wherein computing the minimum length cycle comprises solving a Chinese postman problem.

7. The method defined in claim 1 wherein the forwarding rules are for verifying connectivity of an arbitrary network topology graph by constructing a control flow that traverses each link in the forwarding plane.

8. The method defined in claim 7 wherein constructing a control flow that traverses each link in the forwarding plane comprises:
creating a link adjacency graph;
creating a weighted complete topology graph;
computing a Hamiltonian cycle on the weighted complete topology graph; and
deriving forwarding rules for the control flow based on the Hamiltonian cycle.

9. The method defined in claim 1 wherein the forwarding rules are used for detecting link failures.

10. The method defined in claim 9 wherein detecting link failures comprises:
computing a logical ring topology;
installing routing rules for constructing control flows to loop the logical ring topology in a first direction, the first direction being a clockwise direction or a counter clockwise direction;
installing routing rules for constructing control flows to loop the logical ring topology in a second direction opposite to the first direction; and
installing bounce back rules to switch routing of control flows to a second direction opposite the first direction.

11. The method defined in claim 1 wherein the forwarding rules are used for verifying routability of a network flow.

12. The method defined in claim 11 wherein the forwarding rules correspond to a forward control flow that passes through an execution pipeline of a network flow and to a reverse control flow that is reflected by an egress switch of the network flow following the reverse path of the forward control flow and terminating at a network controller from which the forward control flow started.

13. A communication network comprising:
a network topology of a plurality of nodes that include a control plane, a forwarding plane comprising forwarding elements, and one or more controllers,
wherein the forwarding elements have forwarding rules for identification of network information, wherein the forwarding rules are grouped into one or more separate control flows, where each of the one or more control flows makes a closed loop walk through at least a portion of the network according to the forwarding rules of said each control flow;
at least one of the controllers operable to inject traffic for one or more control flows onto the forwarding plane and identify the network information based on results of injecting the traffic.

14. The network defined in claim 13 wherein the network information comprises one or more of a group consisting of: link failures, topology connectivity, and routability of a pre-determined subset of network flows.

15. The network defined in claim 13 wherein the forwarding rules are for verifying connectivity of an arbitrary network topology graph.

16. The network defined in claim 15 wherein the at least one controller verifies connectivity of the network topology by:
computing an Euler cycle if it exists on the topology graph of the forwarding plane;
computing a minimum length cycle;
installing static rules to route one or more control packets according to the computed minimum length cycle; and
installing dynamic loopback rules at an arbitrary point on the routing loop to send the control flow packets injected by the controller back to the controller after each packet completes one full cycle.

17. The network defined in claim 16 wherein computing the minimum length cycle comprises solving a Chinese postman problem.

18. The network defined in claim 13 wherein the forwarding rules are used for verifying connectivity of the network topology graph.

19. The network defined in claim 18 wherein the at least one controller constructs a control flow that traverses each link in the forwarding plane by:
creating a link adjacency graph;
creating a weighted complete topology graph;
computing a Hamiltonian cycle on the weighted complete topology graph; and
deriving forwarding rules for the control flow based on the Hamiltonian cycle.

20. The network defined in claim 13 wherein the forwarding rules are used for detecting link failures.

21. The network defined in claim 20 wherein the at least one controller detects link failures by:
computing a logical ring topology;
installing routing rules for constructing control flows to loop the logical ring topology in a first direction, the first direction being a clockwise direction or a counter clockwise direction;
installing routing rules for constructing control flows to loop the logical ring topology in a second direction opposite to the first direction; and
installing bounce back rules to switch routing of control flows to a second direction opposite the first direction.

22. The network defined in claim 13 wherein the forwarding rules are used for verifying routability of a network flow.

23. The network defined in claim 22 wherein the forwarding rules correspond to a forward control flow that passes through an execution pipeline of a network flow and to a reverse control flow that is reflected by an egress switch of the network flow following the reverse path of the forward control flow and terminating at a network controller from which the forward control flow started.

24. A method for locating link failures in a network topology, the method comprising:
installing a loopback rule on a node in a logical link topology;
performing a binary search on the logical link topology, wherein performing the binary search by
selecting a node on the logical ring,
sending a control packet in a first direction through the ring,
bouncing back the control packet at the selected node into a second direction through the ring, where the second direction is reverse the first direction, and
receiving the control packet at the controller via a loopback rule installed prior to sending the control packet.

25. A method of locating link failures in a network topology having a plurality of nodes, the method comprising:
specifying a bounce back point in the network for each of a plurality of control packets;
sending the plurality of control packets from one or more points on a constructed logical ring representing the network; and
making a link failure detection decision based on whether successfully receiving the plurality of control packets.
